(19) United States
(12) Patent Application Publication
(10) Pub. No.: US 2025/0264596 A1
(43) Pub. Date: Aug. 21, 2025

(54) INFORMATION TRANSMISSION METHOD, SIGNAL TRANSMISSION METHOD, COMMUNICATION APPARATUS, AND COMMUNICATION SYSTEM

(71) Applicant: HUAWEI TECHNOLOGIES CO., LTD., Shenzhen (CN)

(72) Inventors: Qi FENG, Shanghai (CN); Fan WANG, Shanghai (CN); Zhang ZHANG, Shanghai (CN)

(73) Assignee: HUAWEI TECHNOLOGIES CO., LTD., Shenzhen (CN)

(21) Appl. No.: 19/197,373

(22) Filed: May 2, 2025

Related U.S. Application Data
(63) Continuation of application No. PCT/CN2022/129677, filed on Nov. 3, 2022.

(51) Int. Cl. G01S 13/34; G01S 7/41; G01S 13/931

(52) U.S. Cl. CPC G01S 13/343; G01S 7/414; G01S 13/931

(57) ABSTRACT

This application provides a signal transmission method, a communication apparatus, and a communication system, that serve to suppress interference between signals of a plurality of transceivers sharing a same resource. In the method, a first apparatus generates parameter information and sends the parameter information to a second apparatus, such as a transceiver. The parameter information may be determined based on one or more multiplexing modes. The parameter information indicates a value of at least one of a time shift of a time for transmitting a frequency modulated continuous wave (FMCW) signal relative to a reference time, a slope of the FMCW signal, a plus-minus sign of the slope, and a coding parameter used to generate the FMCW signal through phase coding. The second apparatus receives the parameter information and, generates the FMCW signal based on the received parameter information, and sends the FMCW signal.

### CROSS-REFERENCE TO RELATED APPLICATIONS

This application is a continuation of International Application No. PCT/CN2022/129677, filed on Nov. 3, 2022, the disclosure of which is hereby incorporated by reference in its entirety.

### TECHNICAL FIELD

This application relates to the field of radar technologies, and in particular, to an information transmission method, a signal transmission method, a communication apparatus, and a communication system.

### BACKGROUND

Frequency modulated continuous wave (FMCW) signals are widely used in fields such as intelligent vehicles and autonomous driving. A radar may transmit an FMCW signal through a transmitter antenna to scan the air. If the signal encounters an obstacle, the signal is reflected by the obstacle to form an echo signal. The radar may receive the echo signal through a receiver antenna and detect a target based on the echo signal and the transmitted signal to measure a velocity, a distance, an angle, or the like of the detected target. Herein, the obstacle is the target detected by the radar.

If a plurality of radars transmit FMCW signals by using a same time-frequency resource (which may also be referred to as a resource for short) within a detection range of a radar, the radar may receive echo signals of the plurality of FMCW signals through a receiver antenna. The echo signals interfere with an echo signal of the radar, resulting in an inaccurate detection result.

Therefore, it is desirable to provide a method for effectively suppressing mutual interference between signals when resources used by a plurality of radars overlap.

### SUMMARY

This application provides an information transmission method, a signal transmission method, a communication apparatus, and a communication system, which can suppress mutual interference between signals when resources used by a plurality of transceivers (for example, radars) overlap.

According to a first aspect, this application provides an information transmission method. The method may be performed by a first apparatus. The first apparatus may be, for example, an access network device such as a base station, a server, a terminal, or a component disposed in the foregoing devices, such as a chip, a chip system, a processor, or a logic module or software that can implement some or all functions of the foregoing devices. This is not limited in this application.

The method includes: The first apparatus generates parameter information and sends the parameter information to a second apparatus. The parameter information indicates a value of at least one of the following parameters: a time shift of a time for transmitting an FMCW signal relative to a reference time, a slope of the FMCW signal, a plus-minus sign of the slope, and a coding parameter used to generate the FMCW signal through phase coding. The parameter information is used to generate the FMCW signal.

In this application, the parameter information may be generated and sent for different second apparatuses. Each second apparatus may receive, from the first apparatus, specific values of one or more parameters used to generate the FMCW signal, and generate the FMCW signal based on the parameter information. The one or more parameters included in the parameter information correspond to various multiplexing modes. The multiplexing modes are intended to suppress interference between signals on the basis of sharing a same resource. Therefore, when resources used by a plurality of second apparatuses overlap, interference between FMCW signals generated based on the parameter information can also be suppressed, to help improve the accuracy of the detection results obtained based on the FMCW signals.

The resources used by the plurality of second apparatuses that overlap may include: The resources used by the plurality of second apparatuses are completely the same, or the resources used by the plurality of second apparatuses overlap but are not completely the same. Therefore, when the resources used by the plurality of second apparatuses overlap, the overlapping resource is a resource multiplexed by the plurality of second apparatuses. That the resources used by the plurality of second apparatuses overlap may also be referred to as that the plurality of second apparatuses share a same resource.

A quantity of second apparatuses is not limited in this application. When there is one second apparatus, the first apparatus may still send the parameter information to a transceiver, so that the transceiver generates the FMCW signal based on the parameter information.

In some possible implementations of the first aspect, the parameter information is determined based on a target multiplexing mode. The target multiplexing mode includes one or more of the following multiplexing modes: shift multiplexing, conjugate symmetric multiplexing, slope multiplexing, and phase coding multiplexing.

The shift multiplexing means that a same time-frequency resource is shared by a plurality of FMCW signals generated based on different time shifts. Conjugate symmetric multiplexing means that a same time-frequency resource is shared by two conjugate symmetric FMCW signals. Slope multiplexing means that a same time-frequency resource is shared by a plurality of FMCW signals generated based on different slopes. Phase coding multiplexing means that a same time-frequency resource is shared by a plurality of FMCW signals generated through phase coding based on different values of the coding parameter.

Different target multiplexing modes determine different parameters. For example, the time shift may be determined based on shift multiplexing, the slope may be determined based on slope multiplexing, the plus-minus sign of the slope may be determined based on conjugate symmetric multiplexing, and the coding parameter may be determined based on phase coding multiplexing.

The first apparatus may separately use the foregoing multiplexing modes or use them in combination. In other words, the target multiplexing mode may include one or more of the foregoing multiplexing modes. The plurality of multiplexing modes are provided in order to increase a maximum quantity of transceivers sharing a same resource. Therefore, interference between signals can be effectively suppressed when more transceivers share the same resource.

In some possible implementations of the first aspect, generating the parameter information includes: generating the parameter information for each of a plurality of transceivers multiplexing the time-frequency resource. The parameter information generated for each transceiver is determined based on the target multiplexing mode. Sending the parameter information includes: sending the corresponding parameter information to each of the plurality of transceivers.

In this application, the first apparatus may design different parameter values for different second apparatuses, so that mutual interference between signals can be suppressed when the different second apparatuses share a same resource, to help improve the accuracy of the detection results.

In some possible implementations of the first aspect, the target multiplexing mode includes shift multiplexing. In the parameter information sent to the plurality of transceivers, time shifts indicated by the parameter information for any two of the transceivers are different.

Different time shifts are allocated to different transceivers, so that a low-pass filter of each transceiver can suppress an FMCW signal from another transceiver, to reduce interference between signals of the transceivers.

It should be noted that shift multiplexing by using a time shift may be understood as time shift multiplexing. Because time shift multiplexing and frequency shift multiplexing can be mutually converted, the time shift can also be converted into a frequency shift.

In a possible design, the time shift τₙ indicated by the parameter information for the n^{th} transceiver in the plurality of transceivers meets the following condition: τₙ=(n−1)τₘₐₓ, where n is an integer from 1 to └T/τₘₐₓ┘, T is duration of the FMCW signal, and τₘₐₓ is a maximum round-trip latency of the FMCW signal.

If an interval between times when two transceivers transmit FMCW signals is greater than or equal to τₘₐₓ, there is no interference between the FMCW signals of the two transceivers. In other words, τₘₐₓ is a minimum difference between time shifts of FMCW signals of any two transceivers. In this design, the time shift of each transceiver is set to an integer multiple of τₘₐₓ, so that there is no interference between signals of the transceivers. A value of n does not exceed └T/τₘₐₓ┘, which means that a maximum multiplexing quantity that can be supported by shift multiplexing is └T/τₘₐₓ┘.

In some possible implementations of the first aspect, the target multiplexing mode includes shift multiplexing and conjugate symmetric multiplexing. In the parameter information sent to the plurality of transceivers, parameters indicated by any two pieces of parameter information meet at least one of the following conditions: The time shifts are different, or the plus-minus signs of the slopes are different.

In other words, in parameters used to generate FMCW signals by any two of the plurality of transceivers sharing the same resource, the time shifts are different, and/or the plus-minus signs of the slopes are different.

Shift multiplexing is combined with conjugate symmetric multiplexing, so that a multiplexing quantity is increased in comparison with a maximum multiplexing quantity supported by using shift multiplexing alone and a maximum multiplexing quantity supported by using conjugate symmetric multiplexing alone. This can increase the multiplexing quantity to a greater extent while ensuring that interference is suppressed. Therefore, when more transceivers share the same resource, interference between signals of the more transceivers can be suppressed through parameter design, to help improve the accuracy of the detection results of the transceivers.

In a possible design, the plurality of transceivers include a first transceiver and a second transceiver. In the parameter information sent to the first transceiver and the parameter information sent to the second transceiver, the time shifts are the same, but the plus-minus signs of the slopes are different, so that an FMCW signal s₁(t) of the first transceiver and a signal s₂(t) of the second transceiver meet the following conditions:

$${s}_{1} ( t ) = rect ( \frac{t - T / 2}{T} ) {e}^{j 2 π [ ( {f}_{c} - kT / 2 ) t + {kt}^{2} / 2 ]} and {s}_{2} ( t ) = rect ( \frac{t - T / 2}{T} ) {e}^{j 2 π [ ( {f}_{c} + kT / 2 ) + - {kt}^{2} / 2 ]} ,$$

where t is a time variable, T is the duration of the FMCW signal, f_{c} is a carrier frequency of the FMCW signal, and k is the slope of the FMCW signal.

For two transceivers with a same time shift, plus-minus signs of slopes are designed to achieve phase conjugate symmetry, so that a same time-frequency resource can be shared by two conjugate symmetric signals. The phase conjugate symmetry is specifically the conjugate symmetry of the phases (which may be referred to as baseband phases) except a phase (namely, f_{c}t/2) of a carrier frequency. That is, baseband phases of the FMCW signal of the first transceiver and the FMCW signal of the second transceiver may be respectively represented by kt(t−T)/2 and −kt(t+T)/2.

In some possible implementations of the first aspect, the target multiplexing mode includes shift multiplexing, conjugate symmetric multiplexing, and slope multiplexing. In the parameter information sent to the plurality of transceivers, parameters indicated by the parameter information for any two of the transceivers meet at least one of the following conditions: The time shifts are different, absolute values of the slopes are different, or the plus-minus signs of the slopes are different.

In other words, in parameters used to generate FMCW signals by any two of the plurality of transceivers sharing the same resource, the time shifts are different; the absolute values of the slopes are the same, but the plus-minus signs are different; or the values of the slopes are different.

Shift multiplexing, conjugate symmetric multiplexing, and slope multiplexing are combined, so that a multiplexing quantity is increased in comparison with a maximum multiplexing quantity supported by using shift multiplexing alone, a maximum multiplexing quantity supported by using conjugate symmetric multiplexing alone, and a maximum multiplexing quantity supported by using slope multiplexing alone. This can increase the multiplexing quantity to a greater extent while ensuring that interference is suppressed. Therefore, when more transceivers share the same resource, interference between signals of the more transceivers can be suppressed through parameter design, to help improve the accuracy of the detection results of the transceivers.

In a possible design, slopes for the plurality of transceivers include k₁, k₂, . . . , and kₘ, where k₁<k₂< . . . <kₘ₋₁<kₘ,

$$\frac{{k}_{2} - {k}_{1}}{{k}_{2}^{2}} = \frac{{k}_{3} - {k}_{2}}{{k}_{3}^{2}} = … = \frac{{k}_{m} - {k}_{m 1}}{{k}_{m}^{2}} = q ,$$

kₘ−k₁=Δk, q and Δk are predefined values, Δk=kₘ−k₁, and m=1, 2, . . . , └2/(1−4q²Δk).

Based on the foregoing design, interference between FMCW signals of two transceivers using slope multiplexing can also be effectively suppressed when other parameters are the same.

In some possible implementations of the first aspect, the target multiplexing mode includes shift multiplexing, conjugate symmetric multiplexing, slope multiplexing, and phase coding multiplexing. In the parameter information sent to the plurality of transceivers, parameters indicated by the parameter information for any two of the transceivers meet at least one of the following conditions: The time shifts are different, the absolute values of the slopes are different, the plus-minus signs of the slopes are different, or values of the coding parameter are different.

In other words, in parameters used to generate FMCW signals by any two of the plurality of transceivers sharing the same resource, the time shifts are different; the absolute values of the slopes are the same, but the plus-minus signs are different; the slopes are different; or the values of the coding parameter are different.

Shift multiplexing, conjugate symmetric multiplexing, slope multiplexing, and phase coding multiplexing are combined, so that a multiplexing quantity is increased in comparison with a maximum multiplexing quantity supported by using shift multiplexing alone, a maximum multiplexing quantity supported by using conjugate symmetric multiplexing alone, a maximum multiplexing quantity supported by using slope multiplexing alone, and a maximum multiplexing quantity supported by using phase coding multiplexing alone. This can increase the multiplexing quantity to a greater extent while ensuring that interference is suppressed. Therefore, when more transceivers share the same resource, interference between signals of the more transceivers can be suppressed through parameter design, to help improve the accuracy of the detection results of the transceivers.

In a possible design, a phase coding sequence used for the phase coding is a Zadoff-Chu (ZC) sequence. The coding parameter includes a root sequence index (root index) in the ZC sequence.

Different transceivers may use different root sequence indexes to generate ZC sequences as phase coding sequences. Based on the foregoing design, interference between FMCW signals generated by using different phase coding sequences can also be effectively suppressed when other parameters are the same.

When the ZC sequence is used as the phase coding sequence, a spectrum obtained by multiplying any two phase codes has a constant modulus characteristic. In this case, a corresponding time domain signal is an ideal impulse function, which is conducive to obtaining an accurate detection result. On the contrary, if there is no constant modulus characteristic, a corresponding time-domain signal has a side lobe, which is not conducive to obtaining an accurate detection result.

In another possible design, the phase coding is limited to a binary field. A phase coding sequence used for the phase coding is an m-sequence. The coding parameter includes a cyclic shift of the m-sequence.

If phase coding is limited to the binary field, different cyclic shifts of the m-sequence also have phase coding similar to the constant modulus characteristic. Therefore, the cyclic shift of the m-sequence can also be used as a coding parameter for phase coding. Phase coding sequences may be obtained by using different cyclic shifts as coding parameters of phase coding. After phase codes obtained based on the different cyclic shifts are used to generate FMCW signals, interference between different FMCW signals can also be effectively suppressed.

In some possible implementations of the first aspect, the target multiplexing mode meets at least one of the following conditions: if the multiplexing quantity is less than or equal to a first threshold, the target multiplexing mode includes shift multiplexing; if the multiplexing quantity is greater than the first threshold, the target multiplexing mode includes shift multiplexing and conjugate symmetric multiplexing; if the multiplexing quantity is greater than a second threshold, the target multiplexing mode includes shift multiplexing, conjugate symmetric multiplexing, and slope multiplexing; or if the multiplexing quantity is greater than a third threshold, the target multiplexing mode includes shift multiplexing, conjugate symmetric multiplexing, slope multiplexing, and phase coding multiplexing.

The multiplexing quantity is a quantity of transceivers using a same resource. The first apparatus may select a proper multiplexing mode based on the multiplexing quantity. Therefore, the first apparatus may adjust the multiplexing mode based on a change in the multiplexing quantity, to adapt to the multiplexing quantity. In this way, interference between the signals of the transceivers can be reduced as much as possible, to improve accuracy of detection results.

Optionally, the first threshold is └T/τₘₐₓ┘, the second threshold is 2└T/τₘₐₓ┘, and the third threshold is 2└T/τₘₐₓ┘└2/(1−4q²Δk)┘, where T is the duration of the FMCW signal, τₘₐₓ is the maximum round-trip latency of the FMCW signal, and q and Δk are predefined values.

Thresholds corresponding to different target multiplexing modes are defined, so that the first apparatus has reference when determining parameter values for different quantities of second apparatuses, and does not need to determine the target multiplexing mode once each time parameter information is generated for a second apparatus. Therefore, the amount to be calculated can be reduced, and a proper parameter value can be indicated for the second apparatus in a timely manner.

According to a second aspect, a signal transmission method is provided. The method may be performed by a second apparatus. The second apparatus may be, for example, a transceiver or a terminal configured with a transceiver, or a component disposed in the foregoing devices, such as a chip, a chip system, a processor, or a logic module or software that can implement some or all functions of the foregoing devices. The transceiver includes, for example, a radar. The terminal includes, for example, a vehicle, an unmanned aerial vehicle, or the like. This is not limited in this application.

For example, the method includes: receiving parameter information; generating an FMCW signal based on the parameter; and transmitting the FMCW signal. The parameter information indicates at least one of the following parameters: a time shift of a time for transmitting the FMCW signal relative to a reference time, a slope of the FMCW signal, a plus-minus sign of the slope, and a coding parameter used to generate the FMCW signal through phase coding.

In this application, the second apparatus may determine, based on the parameter information, a parameter used to generate the FMCW signal, and then transmit the FMCW signal. Because the parameter information may be designed by the first apparatus based on a multiplexing mode for transceivers sharing a same resource, interference between the FMCW signal generated by the second apparatus based on the parameter information and a signal of another transceiver can be suppressed, to help improve the accuracy of the detection results of the transceivers.

In some possible implementations, the FMCW signal s(t) meets the following condition:

$$s ( t ) = rect ( \frac{t - τ - T / 2}{T} ) c ( t - τ ) {e}^{j 2 π [ ( {f}_{c} ∓ kT / 2 ) ( t - τ ) \pm {k ( t - τ )}^{2} / 2 ]} ,$$

where rect(.) is a rectangular window function, t is a time variable, τ is the time shift relative to the reference time, T is the duration of the FMCW signal, f_{c} is the carrier frequency of the FMCW signal, k is the slope of the FMCW signal, c(t) is a function of the phase coding, c(t) meets a condition

$$c ( t ) = {\sum }_{l = 1}^{T / {T}_{c}} {c}_{l} rect ( \frac{t - {lT}_{c} / 2}{{T}_{c}} ) ,$$

T_{c} is a chip period of the phase coding, cₗ is a cyclic shift sequence, l=0, 1, . . . , T/T_{c}, and B is bandwidth of the FMCW signal.

It can be learned that the formula as which the FMCW signal is expressed includes the time shift τ, the slope k, and the function c(t) of the phase coding. The first apparatus may suppress, by designing and indicating at least one of the foregoing parameters, interference between FMCW signals generated by transceivers sharing a same resource.

The foregoing formula is merely an example. A person skilled in the art may make simple mathematical transformations or equivalent replacements on the formula based on a same concept. These transformations or replacements shall fall within the protection scope of this application.

In the foregoing possible implementations, the maximum round-trip latency of the FMCW signal is specifically a maximum interval between a time when the FMCW signal is transmitted and a time when an echo signal of the FMCW signal is received.

According to a third aspect, this application provides a communication apparatus, including a module or unit configured to implement the method according to the first aspect or any one of the possible implementations of the first aspect. The module or unit may implement a corresponding function by executing a computer program.

According to a fourth aspect, this application provides a communication apparatus, including a processor. The processor may be configured to implement the method according to the first aspect or any one of the possible implementations of the first aspect by using a logic circuit or executing instructions.

In a possible implementation, the apparatus further includes a communication interface. The communication interface is configured to receive a signal from some communication apparatus other than the communication apparatus and send the signal to the processor, or send a signal from the processor to the other communication apparatus. For example, the communication interface may be a transceiver, a circuit, a bus, a module, or another type of communication interface.

In a possible implementation, the apparatus further includes a memory. The memory is configured to store instructions executed by the processor and/or a configuration file of the logic circuit. The memory is located inside or outside the processor.

In a possible implementation, the apparatus is a chip system. The chip system may include a chip, or may include a chip and another discrete device.

According to a fifth aspect, this application provides a communication apparatus, including a module or unit configured to implement the method according to the second aspect or any one of the possible implementations of the second aspect. It should be understood that the module or unit may implement a corresponding function by executing a computer program.

According to a sixth aspect, this application provides a communication apparatus, including a processor. The processor may be configured to implement the method according to the second aspect or any one of the possible implementations of the second aspect by using a logic circuit or executing instructions.

In a possible implementation, the apparatus further includes a communication interface. The communication interface is configured to receive a signal from some communication apparatus other than the communication apparatus and send the signal to the processor, or send a signal from the processor to the other communication apparatus. For example, the communication interface may be a transceiver, a circuit, a bus, a module, or another type of communication interface.

In a possible implementation, the apparatus further includes a memory. The memory is configured to store instructions executed by the processor and/or a configuration file of the logic circuit. The memory is located inside or outside the processor.

In a possible implementation, the apparatus is a chip system. The chip system may include a chip, or may include a chip and another discrete device.

According to a seventh aspect, this application provides a computer-readable storage medium, including a computer program. When the computer program is run on a computer, the computer is enabled to implement the method according to the first aspect and any one of the possible implementations of the first aspect.

According to an eighth aspect, this application provides a computer program product. The computer program product includes a computer program (which may also be referred to as code or instructions). When the computer program is run, a computer is enabled to perform the method according to the first aspect and any one of the possible implementations of the first aspect.

According to a ninth aspect, an embodiment of this application provides a communication system, including the foregoing first apparatus and second apparatus.

It should be understood that the third aspect to the ninth aspect of this application correspond to the technical solutions of the first aspect and the second aspect of this application, and beneficial effects achieved in the aspects and corresponding feasible implementations are similar. Details are not described again.

### BRIEF DESCRIPTION OF DRAWINGS

FIG. 1 is a diagram of an FMCW signal;

FIG. 2A is a diagram of a communication system applicable to a method according to an embodiment of this application;

FIG. 2B is a diagram of a radar configured to sense an environment;

FIG. 3 is a diagram of a working principle of a radar according to an embodiment of this application;

FIG. 4 is a diagram of mutual interference between radars;

FIG. 5 is a schematic flowchart of an information transmission method according to an embodiment of this application;

FIG. 6 is a diagram of FMCW signals transmitted by two second apparatuses according to an embodiment of this application;

FIG. 7 is a diagram of interference levels of two FMCW signals with different time shifts according to an embodiment of this application;

FIG. 8 is a diagram of a plurality of FMCW signals with different time shifts according to an embodiment of this application;

FIG. 9 is another diagram of FMCW signals transmitted by two second apparatuses according to an embodiment of this application;

FIG. 10 is a diagram of interference levels of two conjugate symmetric FMCW signals according to an embodiment of this application;

FIG. 11 is still another diagram of FMCW signals transmitted by two second apparatuses according to an embodiment of this application;

FIG. 12 is a diagram of interference levels of a plurality of FMCW signals with different slopes according to an embodiment of this application;

FIG. 13 is a diagram of two FMCW signals generated through phase coding based on different coding parameters according to an embodiment of this application;

FIG. 14 is a diagram of interference levels of two FMCW signals generated through phase coding based on different coding parameters according to an embodiment of this application; and

FIG. 15 and FIG. 16 are block diagrams of apparatuses according to embodiments of this application.

### DESCRIPTION OF EMBODIMENTS

The following describes technical solutions of this application with reference to the accompanying drawings.

For ease of understanding embodiments of this application, the term “frequency modulated continuous wave (FMCW) signal” is first briefly described.

The FMCW signal is an electromagnetic wave signal whose frequency linearly changes over time. Generally, the linear change is a linear change in one transmission period. An FMCW signal in one transmission period may be referred to as a chirp signal.

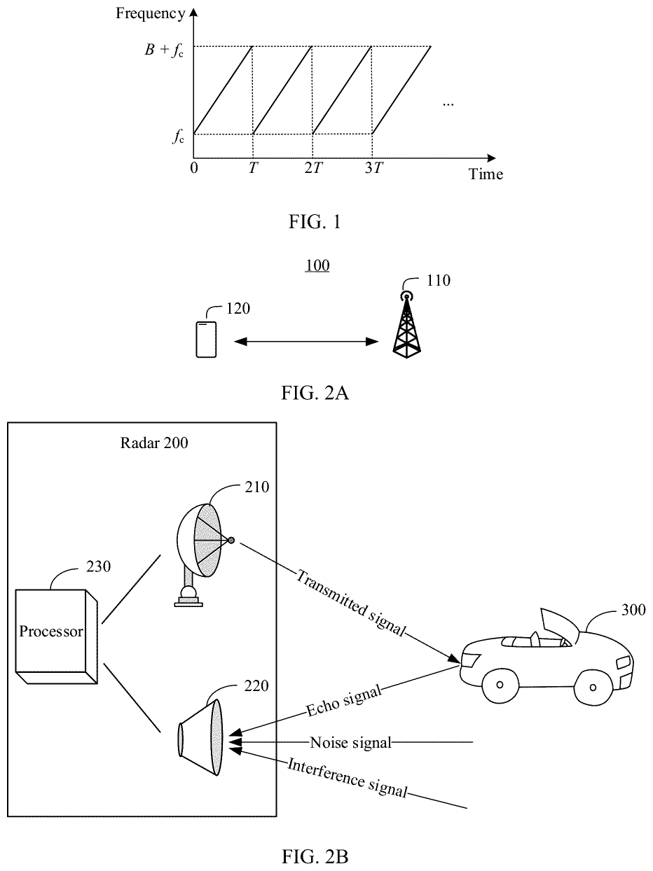

FIG. 1 is a diagram of an FMCW signal. FIG. 1 shows a plurality of FMCW signals arranged at equal spacings in time. A single FMCW signal is expressed as follows:

$$s ( t ) = ( \frac{t - T / 2}{T} ) {e}^{j 2 π ( {f}_{c} + {kt}^{2} )}$$

where rect(.) is a rectangular window function. In the expression rect

$$( t ) = \{ \begin{matrix}1 , & - 1 / 2 \leq t \leq 1 / 2 \\ 0 , & others\end{matrix} ,$$

“others” represents a case other than −1/2≤t≤1/2, t is a time variable, f_{c} is a carrier frequency of the FMCW signal, and k is a slope of the FMCW signal.

As shown in FIG. 1, the plurality of FMCW signals may be continuously transmitted in time. A duration of one FMCW signal is T. A frequency band occupied by the FMCW signal in the frequency domain is bandwidth B of the FMCW signal. For example, the frequency band occupied by the FMCW signal in FIG. 1 is f_{c} to B+f_{c}. The duration T of the FMCW signal meets the following condition: T=B/k.

Generally, in some possible implementations, a frequency band for transmitting an FMCW signal is a millimeter-wave band (for example, 77 gigahertz (GHz)), and the bandwidth is 1 GHz to 4 GHz. In other words, in the foregoing formula, f_{c} is 77 GHz, and B is 1 GHz to 4 GHz.

An interference level is introduced in this application to quantize interference between signals in different multiplexing modes. The interference level may be understood as a physical quantity used to represent an average interference power. If the interference is not zero, the interference level may be represented by a reciprocal of a signal-to-interference ratio. If the interference is zero, the interference level is also zero. The smaller the interference, the lower the interference level. The larger the interference, the higher the interference level.

FIG. 2A shows an example of a communication system applicable to a method according to an embodiment of this application. With reference to FIG. 2A, a communication system 100 includes at least one network device 110 and at least one terminal 120. One or more transceivers may be disposed in the network device 110 or the terminal 120. The transceiver may be, for example, a radar, and may transmit an FMCW signal.

The terminal 120 mentioned in embodiments of this application may be a device having a wireless transceiver function, and may be specifically user equipment (UE), an access terminal, a subscriber unit, a subscriber station, a mobile station, a remote station, a remote terminal, a mobile device, a user terminal, a wireless communication device, a user agent, or a user apparatus. Alternatively, the terminal device may be a satellite phone, a cellular phone, a smartphone, a wireless data card, a wireless modem, a machine type communication device, a cordless phone, a session initiation protocol (SIP) phone, a wireless local loop (WLL) station, a personal digital assistant (PDA), a handheld device having a wireless communication function, a computing device or another processing device connected to a wireless modem, a vehicle-mounted device, a communication device carried on a high-altitude aircraft, a wearable device, an unmanned aerial vehicle, a robot, a smart point of sale (POS) machine, customer-premises equipment (CPE), a terminal in device-to-device (D2D) communication, a terminal in vehicle to everything (V2X), a virtual reality (VR) terminal device, an augmented reality (AR) terminal device, a wireless terminal in industrial control, a wireless terminal in self driving, a wireless terminal in telemedicine (remote medical), a wireless terminal in a smart grid, a wireless terminal in transportation safety, a wireless terminal in a smart city, a wireless terminal in a smart home, a terminal device in a communication network evolved after 5G, or the like. This is not limited in this application.

In embodiments of this application, an apparatus configured to implement a function of the terminal device may be a terminal device, or may be an apparatus that can support the terminal device in implementing the function, for example, a chip system. The apparatus may be mounted in a terminal device or used in a manner of matching a terminal device. In embodiments of this application, the chip system may include a chip, or may include a chip and another discrete device.

The network device 110 is a device having a wireless transceiver function, and is configured to communicate with the terminal device, or may be a device that allows the terminal device to access a wireless network. The network device may be a node in a radio access network, and may also be referred to as a base station, or may be referred to as a radio access network (RAN) node (or device). The network device may be an evolved NodeB (eNB or eNodeB) in long term evolution (LTE), a next generation NodeB (gNB) in a 5G network or a base station in a future evolved public land mobile network (PLMN), a broadband network gateway (BNG), an aggregation switch or a non-3rd generation partnership project (3GPP) access device, or the like. Optionally, the network device in embodiments of this application may include various forms of base stations, for example, a macro base station, a micro base station (also referred to as a small cell), a relay station, an access point, a device that implements a base station function in a communication system evolved after 5G, an integrated access and backhaul (IAB) node, an access point (AP) in a Wi-Fi system, a transmitting and receiving point (TRP), a transmitting point (TP), a mobile switching center, a device that implements the base station function in device-to-device (D2D), vehicle-to-everything (V2X), or machine-to-machine (M2M) communication, and the like; may further include a central unit (CU) and a distributed unit (DU) in a cloud radio access network (C-RAN) system, or a network device in a non-terrestrial network (NTN) communication system, that is, may be deployed on a high-altitude platform or a satellite; or may be various devices that form access nodes, such as an active antenna unit (AAU) and a baseband unit (BBU). This is not limited in embodiments of this application.

FIG. 2B is a diagram of a radar configured to sense an environment. It should be understood that the radar is an example of a transceiver, and should not constitute any limitation on this application. FIG. 2B shows an application scenario to which this application is applicable by using an example, and does not limit the application scenario. FIG. 2B shows components included in a radar 200 by using an example, and does not limit the radar 200.

With reference to FIG. 2B, the radar 200 and a vehicle 300 are shown in the application scenario. The vehicle 300 is an obstacle detected by the radar 200. The radar 200 may be disposed in a device such as a vehicle or an unmanned aerial vehicle, and is configured to sense a surrounding environment.

For example, the radar 200 may include a transmitter antenna 210, a receiver antenna 220, and a processor 230. The transmitter antenna 210 may be configured to transmit a signal. In embodiments of this application, the transmitter antenna 210 may be configured to transmit an FMCW signal. In the following, for ease of description, the signal transmitted by the transmitter antenna 210 is referred to as a transmitted signal. The transmitter antenna 210 may transmit signals in a plurality of directions. For example, the processor 230 may control the transmitter antenna 210 to transmit signals in different directions. After the transmitted signal reaches the obstacle, the obstacle may reflect the transmitted signal. A signal formed after the obstacle reflects the transmitted signal may be referred to as an echo signal. As shown in FIG. 2B, the vehicle 300 is an example of the obstacle. After reaching the vehicle 300, the transmitted signal is reflected to form the echo signal.

The receiver antenna 220 may be configured to receive a signal. The receiver antenna 220 may receive an echo signal, a noise signal, and an interference signal. The echo signal includes an echo signal of a signal transmitted by the radar 200. For example, the interference signal may include a transmitted signal of another radar, its echo signal, and the like.

The processor 230 may obtain the signal received by the receiver antenna 220, and determine the echo signal of the radar 200 from the signal received by the receiver antenna 220. The processor 230 may further obtain the signal transmitted by the transmitter antenna 210, and perform target detection and measurement on the obstacle based on the transmitted signal and the echo signal. Herein, the obstacle is a target detected by the radar, or is referred to as an object. Measurement on the target may include: measuring a velocity of the target (namely, a velocity measurement), measuring a distance between the target and the radar (namely, ranging), measuring a location of the target (namely, positioning), and the like. The target may be a vehicle, an aircraft, or the like. This application includes but is not limited thereto.

For example, measuring the velocity of the target may be measuring a radial velocity of the target relative to the radar. The velocity of the target may meet the following condition: vₜ=λ·f_{d}/2 where vₜ represents the radial velocity of the target relative to the radar, λ represents a wavelength of the transmitted signal, and f_{d} represents a frequency shift of the echo signal relative to the transmitted signal, namely, a Doppler frequency shift.

Measuring the distance of the target may be measuring a distance of the target relative to the radar. The distance of the target may be determined based on a difference between a time when the transmitter antenna transmits the signal and a time when the receiver antenna receives the echo signal.

The location of the target may be determined based on a location of the radar and a result of measuring the distance of the target.

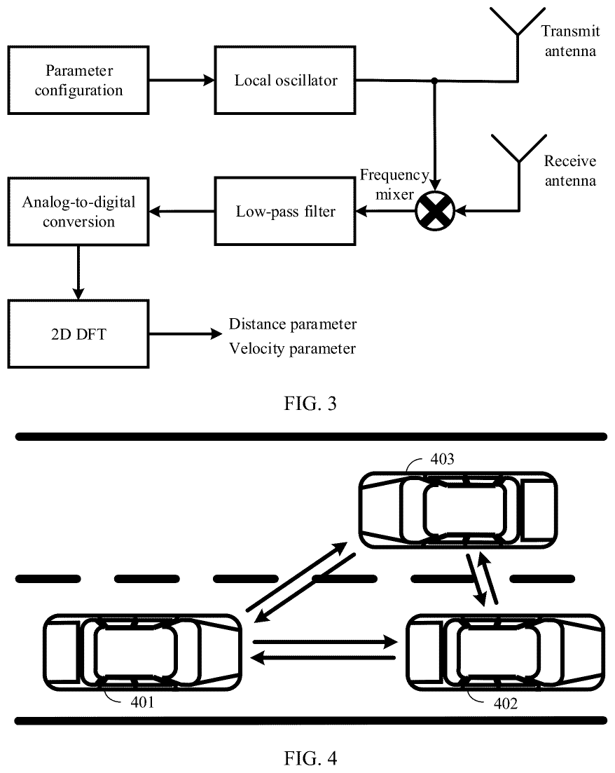

FIG. 3 is a diagram of a working principle of a radar according to an embodiment of this application. For example, as shown in FIG. 3, a processor of the radar may configure parameters of an FMCW signal, such as a frequency (or time) shift and a slope. A local oscillator generates the FMCW signal based on the configured parameters. The FMCW signal is divided into two signals. One signal enters a transmitter antenna and is radiated to space through the transmitter antenna. The other signal enters a frequency mixer. If the transmitted signal encounters an obstacle, the transmitted signal is reflected to form an echo signal. After being received by a receiver antenna, the echo signal arrives at the frequency mixer. The frequency mixer mixes the echo signal from the receiver antenna with the locally generated FMCW signal, and then outputs a beat frequency signal. The beat frequency signal passes through a low-pass filter and then undergoes analog-to-digital conversion to obtain a digital signal. Then, a distance parameter and a velocity parameter may be obtained by performing two-dimensional discrete Fourier transform (DFT) on the digital signal. The distance parameter may be a frequency in a power spectrum obtained through primary DFT (also referred to as distance processing). The velocity parameter may be a Doppler frequency in a fuzzy function obtained through secondary DFT (also referred to as velocity processing).

Although FIG. 3 shows one transmitter antenna and one receiver antenna, quantities of transmitter antennas and receiver antennas of the radar are not limited in this application. In addition, processing on the received signal is not limited to the foregoing description. This is not limited in this application.

As described above, because an interference signal received by a radar is from another radar, in a range that can be reached by a transmitted signal of a radar, if there is also a transmitted signal of another radar, the radar may be interfered with by the other radar.

FIG. 4 is a diagram of mutual interference between radars. FIG. 4 shows three vehicles 401 to 403 configured with radars. The three vehicles are in a range that can be reached by a transmitted signal from each other. FMCW signals work in a fixed frequency band and have bandwidth of 1 GHz to 4 GHZ. Therefore, if the three vehicles 401 to 403 simultaneously transmit signals through their radars, the signals from different radars may interfere with each other. The signal transmitted by the vehicle 401 may reach the vehicles 402 and 403. The signal transmitted by the vehicle 402 may reach the vehicles 401 and 403. The signal transmitted by the vehicle 403 may reach the vehicles 401 and 402. Therefore, the vehicle 401 may receive its own echo signal and the transmitted signals and/or echo signals from the vehicles 402 and 403. The vehicle 402 may receive its own echo signal and the transmitted signals and/or echo signals from the vehicles 401 and 403. The vehicle 403 may receive its own echo signal and the transmitted signals and/or echo signals from the vehicles 401 and 402.

The signal received by any one of the vehicles 401 to 403 may have a plurality of peaks after two-dimensional DFT. This causes interference to a detection result, resulting in an inaccurate detection result.

Accordingly, this application provides a method in which a first apparatus allocates, to a plurality of second apparatuses sharing a same resource, parameters used to generate FMCW signals, so that different second apparatuses can generate FMCW signals based on parameters with different values. The first apparatus may control the plurality of second apparatuses sharing the same resource, so that values of the parameters used by the second apparatuses to generate the FMCW signals are different. Therefore, a difference exists between the FMCW signals generated by the second apparatuses, and interference between the FMCW signals of the second apparatuses is suppressed, to help improve the accuracy of the detection results.

The method provided in this application may be used to suppress interference between signals of a plurality of second apparatuses. The plurality of second apparatuses may be, for example, transceivers respectively disposed in a plurality of terminals, or a plurality of transceivers disposed in one terminal device. This is not limited in this application.

The following describes in detail the method provided in this application with reference to the accompanying drawings.

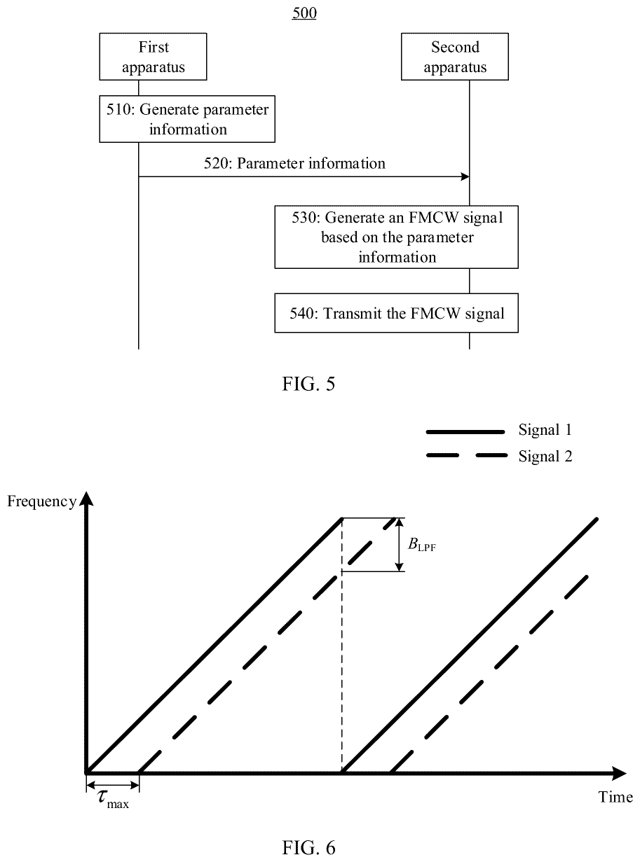

FIG. 5 is a schematic flowchart of an information transmission method according to an embodiment of this application. It should be understood that FIG. 5 shows the foregoing method from a perspective of an interaction between a first apparatus and a second apparatus. The first apparatus may be, for example, a base station or another access network device, a server, or a component disposed in the foregoing devices, such as a chip, a chip system, a processor, a terminal, or a logic module or software that can implement some or all functions of the foregoing devices. The second apparatus may be, for example, a transceiver or a terminal configured with a transceiver, or a component disposed in the foregoing devices, such as a chip, a chip system, a processor, or a logic module or software that can implement some or all functions of the foregoing devices. The transceiver may be, for example, a radar. The terminal configured with the transceiver includes, for example, a vehicle, an unmanned aerial vehicle, or the like. This is not limited in this application.

A method 500 shown in FIG. 5 may include:
Step 510: The first apparatus generates parameter information. The parameter information indicates a value of at least one of the following parameters: a time shift of a time for transmitting an FMCW signal relative to a reference time, a slope of the FMCW signal, a plus-minus sign of the slope, and a coding parameter used to generate the FMCW signal through phase coding. The parameter information is used to generate the FMCW signal.
Step 520: The first apparatus sends the parameter information to the second apparatus. Correspondingly, the second apparatus receives the parameter information from the first apparatus.
Step 530: The second apparatus generates the FMCW signal based on the parameter information.
Step 540: The second apparatus transmits the FMCW signal.

In embodiments of this application, the first apparatus may determine the value of at least one of the foregoing parameters based on a multiplexing mode. For example, different time shifts are determined based on a shift multiplexing mode, and different slopes are determined based on a slope multiplexing mode. The first apparatus may allocate different parameters to different second apparatuses. The different parameters may be determined based on the multiplexing mode. Because the multiplexing mode can be used to suppress interference between signals, the parameter values determined based on the multiplexing mode can suppress, to some extent, interference between signals transmitted by different second apparatuses sharing a same resource.

The following describes the steps in the method 500 in detail.

In step 510, the first apparatus may determine values of one or more parameters for the second apparatus, and may generate the parameter information based on the determined value of each parameter.

For example, the first apparatus may determine a time shift for the second apparatus. Time shifts determined for different second apparatuses are different, and other parameters, such as absolute values of slopes, plus-minus signs of the slopes, and coding parameters for phase coding, may be the same or different. In this case, the first apparatus may generate the parameter information based on the time shift, and does not additionally indicate the absolute value of the slope, the plus-minus sign of the slope, and the coding parameter for the phase coding.

In this case, in a possible implementation, default values of the foregoing parameters may be preconfigured in the second apparatus. For example, a default value of the time shift, a default selection of the plus-minus sign of the slope, a default value of the slope, and a default value of the coding parameter for the phase coding are configured. Alternatively, the first apparatus may send the default values of the foregoing parameters to each second apparatus in advance. When finding that values of one or more parameters are not indicated by the parameter information, the second apparatus may use the default values. In another possible implementation, the second apparatus may determine a value of a parameter that is not indicated by the parameter information.

The parameter information may directly indicate the value of each parameter, or may indicate the value of each parameter through another identifier. It should be understood that the value of each parameter indicated by the parameter information is a value of each of one or more parameters that is determined by the first apparatus, and does not represent that the parameter information indicates the value of each of the foregoing four parameters.

A possible implementation in which the parameter information directly indicates the value of each parameter is that the parameter information carries the value of each parameter. In this way, the second apparatus can directly determine the value of each parameter based on the parameter information.

Another possible implementation in which the parameter information directly indicates the value of each parameter is that the parameter information carries an offset of the value of each parameter relative to the default value. For example, for the value of the time shift, an offset relative to the default value of the time shift is indicated. For the value of the slope, an offset relative to the default value of the slope is indicated. For the coding parameter for the phase coding, an offset relative to the default value of the coding parameter is indicated. For the selection of the plus-minus sign of the slope, an offset relative to the default selection of the plus-minus sign of the slope is indicated. For example, a preset value “0” may be used to represent that the default selection is the same as an actually determined plus-minus sign. A preset value “1” may be used to represent that the default selection is opposite to the actually determined plus-minus sign. For example, if the default plus-minus sign of the slope is a plus sign and the actually determined plus-minus sign of the slope is a minus sign, “1” may be used for representation. If the default plus-minus sign of the slope is the plus sign and the actually determined plus-minus sign of the slope is also the plus sign, “0” may be used for representation. The offset is indicated, so that indication overheads caused by the parameter information can be reduced, and it is also convenient for the second apparatus to determine the value of each parameter based on the parameter information.

In a possible implementation in which the parameter information indicates the value of each parameter through another identifier, the parameter information carries an index corresponding to the value of each parameter.

In an example, the first apparatus and the second apparatus preconfigure a mapping relationship between a plurality of values of each parameter and a plurality of indexes. Each value corresponds to one index. A total of four parameters are involved in embodiments of this application. Therefore, the first apparatus and the second apparatus may preconfigure mapping relationships respectively corresponding to the four parameters. The first apparatus may determine, based on the value of each parameter determined for the second apparatus, the corresponding index from the mapping relationship of the parameter, to generate the parameter information. In this way, the generated parameter information may carry indexes corresponding to values of one or more parameters.

In another example, the first apparatus and the second apparatus preconfigure a plurality of mapping relationships between a plurality of combinations of values of a plurality of parameters and a plurality of indexes. Each mapping relationship includes a combination of the values of the plurality of parameters and the index corresponding to the combination. The first apparatus may determine the corresponding index from the plurality of preconfigured mapping relationships based on the values of the parameters determined for the second apparatus, to generate the parameter information. In this way, the generated parameter information may carry the index corresponding to the combination of the values of the plurality of parameters.

The foregoing example is provided only for ease of understanding, and the parameter information may alternatively be formed in another manner. For example, the parameter information may alternatively be an index corresponding to the offset between the value and the default value of each parameter. For a specific implementation, refer to the foregoing example. Details are not described herein again.

Optionally, step 510 includes: The first apparatus generates the parameter information for each of a plurality of second apparatuses. The parameter information generated for each second apparatus is determined based on a target multiplexing mode. Step 520 includes: The first apparatus sends the corresponding parameter information to each of the plurality of second apparatuses.

As described above, the second apparatuses may be disposed in different terminals. Therefore, step 510 may specifically include: The first apparatus generates the parameter information for each of a plurality of second apparatuses sharing a same resource to transmit FMCW signals. Step 520 may specifically include: The first apparatus sends the parameter information for each of the plurality of second apparatuses sharing the same resource to transmit the FMCW signals.

In a possible implementation in which the first apparatus sends the parameter information to each second apparatus, the first apparatus sends the corresponding parameter information to each second apparatus in unicast mode. This can make it convenient for the second apparatus to directly determine the value of each parameter based on the received parameter information, and avoid resource collision that may be caused when the plurality of second apparatuses use a same parameter value.

In another possible implementation in which the first apparatus sends the parameter information to each second apparatus, the first apparatus sends, in broadcast mode, the parameter information separately generated for the plurality of second apparatuses. Parameter information for different apparatuses may be distinguished through different identifiers. The identifier may be, for example, a device identifier of the second apparatus. This allows the second apparatus to identify, based on the identifier, the parameter information allocated to itself, to determine the value of each parameter, and can avoid resource collision that may be caused when the plurality of second apparatuses use a same parameter value.

A specific implementation in which the first apparatus sends the parameter information to each second apparatus is not limited to the foregoing two implementations. For example, alternatively, the first apparatus may send, in broadcast mode, the parameter information separately generated for the plurality of second apparatuses, and each second apparatus may choose from the received parameter information for use. If the plurality of second apparatuses are disposed in a same terminal, the terminal may allocate different parameter values to different second apparatuses based on the received parameter information sent in the broadcast mode.

In embodiments of this application, the first apparatus may determine the value of at least one of the foregoing parameters based on a quantity of second apparatuses sharing a same time-frequency resource. The quantity of second apparatuses sharing the same time-frequency resource may be referred to as a multiplexing quantity for short.

It should be noted that a plurality of second apparatuses sharing a same time-frequency resource may indicate that resources used by the plurality of second apparatuses overlap, but does not indicate that the resources used by the plurality of second apparatuses to transmit FMCW signals are completely the same. That the resources used by the plurality of second apparatuses overlap may specifically include: The resources used by the plurality of second apparatuses are the same, or the resources used by the plurality of second apparatuses overlap but are not completely the same. Therefore, when the resources used by the plurality of second apparatuses overlap, the overlapping resource is a resource multiplexed by the plurality of second apparatuses.

As described above, the second apparatuses may be disposed in different devices, such as a vehicle, an unmanned aerial vehicle, and the like. Therefore, the multiplexing quantity may also be a quantity of devices sharing a same time-frequency resource to transmit FMCW signals, or a quantity of second apparatuses sharing a same time-frequency resource to transmit FMCW signals.

The multiplexing quantity may be considered based on a range that can be controlled by the first apparatus. For example, the first apparatus is a base station, the multiplexing quantity may be a quantity of second apparatuses within signal coverage of the base station, and the second apparatuses may include but are not limited to an in-vehicle radar, an airborne radar, and the like.

In embodiments of this application, the first apparatus may determine the multiplexing mode based on the multiplexing quantity, and further determine the value of at least one of the foregoing parameters based on the multiplexing mode.

In a possible implementation, the multiplexing mode includes shift multiplexing, conjugate symmetric multiplexing, slope multiplexing, and phase coding multiplexing. The first apparatus may determine, from the foregoing plurality of multiplexing modes based on the multiplexing quantity, a multiplexing mode that adapts to the multiplexing quantity. For ease of distinction and description, the multiplexing mode determined based on the multiplexing quantity is denoted as the target multiplexing mode in this specification. The target multiplexing mode may be one or more of shift multiplexing, conjugate symmetric multiplexing, slope multiplexing, or phase coding multiplexing.

Optionally, the target multiplexing mode meets at least one of the following conditions:
if the multiplexing quantity is less than or equal to a first threshold, the target multiplexing mode includes shift multiplexing;
if the multiplexing quantity is greater than the first threshold, the target multiplexing mode includes shift multiplexing and conjugate symmetric multiplexing;
if the multiplexing quantity is greater than a second threshold, the target multiplexing mode includes shift multiplexing, conjugate symmetric multiplexing, and slope multiplexing; or
if the multiplexing quantity is greater than a third threshold, the target multiplexing mode includes shift multiplexing, conjugate symmetric multiplexing, slope multiplexing, and phase coding multiplexing.

Thresholds corresponding to different target multiplexing modes are defined, so that the first apparatus can select target multiplexing modes more properly for different multiplexing quantities, to determine parameter values for different quantities of second apparatuses. In addition, the first apparatus does not need to determine the target multiplexing mode once each time parameter information is generated for a second apparatus. Therefore, the amount to be calculated can be reduced, and a proper parameter value can be indicated for the second apparatus in a timely manner.

The first threshold, the second threshold, and the third threshold may be determined based on maximum multiplexing quantities supported by different target multiplexing modes. For example, the first threshold is └τₘₐₓ┘, the second threshold is 2└T/τₘₐₓ┘, and the third threshold is 2└T/τₘₐₓ┘└2/(1−4q²Δk)┘ where τₘₐₓ is a maximum round-trip latency of the FMCW signal, and q and Δk are predefined values. The maximum multiplexing quantity supported by each multiplexing mode is described below with reference to different multiplexing modes, and is not described in detail herein.

When the target multiplexing mode includes different multiplexing modes, the corresponding thresholds also change.

For example, the first threshold is └T/τₘₐₓ┘, the second threshold is └T/τₘₐₓ┘└2/(1−4q²Δk)┘, and the third threshold is 2└T/τₘₐₓ┘└2/(1−4q²Δk)┘. The target multiplexing mode may meet the following conditions: If the multiplexing quantity is less than or equal to the first threshold, the target multiplexing mode includes shift multiplexing; if the multiplexing quantity is greater than the first threshold, the target multiplexing mode includes shift multiplexing and slope multiplexing; if the multiplexing quantity is greater than the second threshold, the target multiplexing mode includes shift multiplexing, slope multiplexing, and conjugate symmetric multiplexing; or if the multiplexing quantity is greater than the third threshold, the target multiplexing mode includes shift multiplexing, slope multiplexing, conjugate symmetric multiplexing, and phase coding multiplexing.

For another example, the first threshold is 2, the second threshold is 2└T/τₘₐₓ┘, and the third threshold is 2└T/τₘₐₓ┘└2/(1−4q²Δk)┘. The target multiplexing mode may meet the following conditions: If the multiplexing quantity is less than or equal to the first threshold, the target multiplexing mode includes conjugate symmetric multiplexing; if the multiplexing quantity is greater than the first threshold, the target multiplexing mode includes conjugate symmetric multiplexing and shift multiplexing; if the multiplexing quantity is greater than the second threshold, the target multiplexing mode includes shift multiplexing, slope multiplexing, and conjugate symmetric multiplexing; or if the multiplexing quantity is greater than the third threshold, the target multiplexing mode includes shift multiplexing, slope multiplexing, conjugate symmetric multiplexing, and phase coding multiplexing.

The foregoing examples of the thresholds are merely examples, and shall not constitute any limitation on this application. A person skilled in the art may determine other possible values of the thresholds based on a same concept, which are not enumerated herein.

To facilitate understanding of a method for determining the target multiplexing mode by the first apparatus based on the multiplexing quantity, the following first describes the foregoing several multiplexing modes in detail.

1. Shift multiplexing: This includes time shift multiplexing and frequency shift multiplexing. Time shift multiplexing means that a same time-frequency resource is shared by a plurality of FMCW signals generated based on different time shifts, and each FMCW signal corresponds to one time shift. Frequency shift multiplexing means that a same time-frequency resource is shared by a plurality of FMCW signals generated based on different frequency shifts, and each FMCW signal corresponds to one frequency shift. In a possible implementation, the plurality of FMCW signals are signals from different second apparatuses.

In this specification, the parameter information generated by the first apparatus may be used to indicate a time shift. However, a person skilled in the art may understand that the time shift can also be converted into a frequency shift.

For example, it is assumed that the time shift is τ₀. An FMCW signal generated by using the time shift is as follows:

$$s ( t ) = rect ( \frac{t - {τ}_{0} - T / 2}{T} ) {e}^{j 2 π [ ( {f}_{c} - kT / 2 ) ( t - {τ}_{0} ) + {k ( t - {τ}_{0} )}^{2} / 2 ]}$$

If the time shift τ₀ and a frequency shift f₀ meet a condition f₀=kτ₀, the FMCW signal generated by using the time shift may be converted into the following FMCW signal generated by using the frequency shift:

$$s ( t ) = rect ( \frac{t - T / 2}{T} ) {e}^{j 2 π [ ( {f}_{c} - {f}_{0} ) t + {kt}^{2} / 2 ]}$$

For brevity, the following embodiments are described by using the time shift as an example.

The time shift may be specifically an offset of the time for transmitting the FMCW signal relative to the reference time. The reference time may be a time that can be shared by all second apparatuses, and may be specifically a specific time point, for example, a universal time coordinated (UTC), or may be a time domain resource in a radio resource, for example, a time unit, such as a slot or a symbol. This is not limited in this application. Each second apparatus may synchronize time with the first apparatus in advance, to determine, based on a same reference time, a time for transmitting an FMCW signal by each second apparatus.

The time shift multiplexing mode is used between two second apparatuses, which does not indicate that different time domain resources are used for FMCW signals transmitted by the two second apparatuses. It can be learned from FIG. 1 that the FMCW signals are in a continuous waveform. In time shift multiplexing mode, the two second apparatuses are distinguished only in terms of a transmission time, so that the two second apparatuses transmit the FMCW signals at different times.

Generally, for a plurality of second apparatuses, if an FMCW signal has a same time shift as a local oscillator, a beat frequency signal output by a frequency mixer falls within a passband of a low-pass filter. If the FMCW signal has a different time shift from the local oscillator, the beat frequency signal output by the frequency mixer falls within a stopband of the low-pass filter.

If an interval between times when two second apparatuses transmit FMCW signals is controlled to be greater than or equal to a maximum round-trip latency τₘₐₓ of the FMCW signals, interference between the FMCW signals of the two second apparatuses is almost zero. Herein, the maximum round-trip latency of the FMCW signal is a maximum interval between a time when the FMCW signal is transmitted and a time when an echo signal of the FMCW signal is received.

It may be understood that for an FMCW signal whose slope is k, a maximum frequency difference between the signal transmitted and the signal received by the second apparatus is kτₘₐₓ. Therefore, the passband bandwidth required by the low-pass filter is B_{LPF}=kτₘₐₓ. In other words, a range of beat frequency signals that can be supported by the low-pass filter is [0,kτₘₐₓ].

FIG. 6 is a diagram of FMCW signals transmitted by two second apparatuses according to an embodiment of this application. The two second apparatuses may be denoted as an apparatus 1 and an apparatus 2. The FMCW signal transmitted by the apparatus 1 is denoted as a signal 1 and denoted as s₁(t). The FMCW signal transmitted by the apparatus 2 is denoted as a signal 2 and denoted as s₂(t). The signal 1 and the signal 2 are respectively expressed as the following formulas 1 and 2:

$$s ( t ) = rect ( \frac{t - {τ}_{1} - T / 2}{T} ) {e}^{j 2 π [ ( {f}_{c} - kT / 2 ) ( t - {τ}_{1} ) + {k ( t - {τ}_{1} )}^{2} / 2 ]} \qquad Formula 1$$

$$s ( t ) = rect ( \frac{t - {τ}_{2} - T / 2}{T} ) {e}^{j 2 π [ ( {f}_{c} - kT / 2 ) ( t - {τ}_{2} ) + {k ( t - {τ}_{2} )}^{2} / 2 ]} \qquad Formula 2$$

In these formulas/is a time variable, τ₁ and τ₂ are offsets of times for transmitting the signal 1 and the signal 2 relative to a reference time, namely, time shifts corresponding to the signal 1 and the signal 2. τ₁ and τ₂ may meet the following condition: |τ₁−τ₂≥τₘₐₓ. It can be learned that the signal 1 and the signal 2 have same parameters except the time shift.

It should be understood that the reference time is not shown in the formula, and it may be understood that the reference time is zero. If the reference time is denoted as t₀, formulas 1 and 2 may also be transformed as follows:

$${s}_{1} ( t ) = rect ( \frac{t - {t}_{0} - {τ}_{1} - T / 2}{T} ) {e}^{j 2 π [ ( {f}_{c} - kT / 2 ) ( t - {t}_{0} - {τ}_{1} ) + {k ( t - {t}_{0} - {τ}_{1} )}^{2} / 2 ]} \qquad Formula 1 - 1$$

$${s}_{2} ( t ) = rect ( \frac{t - {t}_{0} - {τ}_{2} - T / 2}{T} ) {e}^{j 2 π [ ( {f}_{c} - kT / 2 ) ( t - {t}_{0} - {τ}_{2} ) + {k ( t - {t}_{0} - {τ}_{2} )}^{2} / 2 ]} \qquad Formula 2 - 1$$

FIG. 6 shows FMCW signals when an interval between the times for transmitting the signal 1 and the signal 2 is τₘₐₓ. It can be learned that when the other parameters are the same and a difference between the time shifts of the signal 1 and the signal 2 is τₘₐₓ, a difference between frequencies of the signal 1 and the signal 2 at a same time point is exactly B_{LPF}.

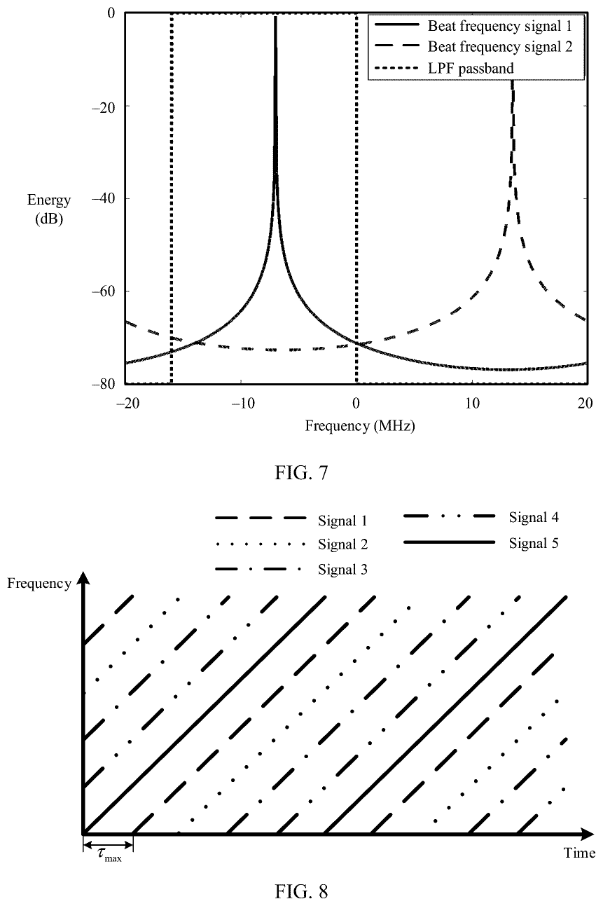

FIG. 7 is a diagram of interference levels of two FMCW signals with different time shifts according to an embodiment of this application. Energy of beat frequency signals is shown in the figure. After echo signals of the signal 1 and the signal 2 are received by the apparatus 1, a frequency mixer may output beat frequency signals based on the locally generated signal 1 and the received echo signals of the signal 1 and the signal 2. A beat frequency signal 1 output by the frequency mixer based on the local signal 1 and the received echo signal of the signal 1 is shown by a solid line in the figure. A beat frequency signal 2 output by the frequency mixer based on the local signal 1 and the received echo signal of the signal 2 is shown by a dashed line in the figure. It can be learned that an energy peak (namely, a main lobe) of the beat frequency signal 1 is obvious and falls within a passband of a low-pass filter, and an energy peak of the beat frequency signal 2 falls outside the passband of the low-pass filter, that is, falls within a stopband of the low-pass filter. Therefore, the signal 2 has zero interference for the apparatus 1.

Similarly, although not shown in the figure, it can be determined that if the echo signals of the signal 1 and the signal 2 are received by the apparatus 2, in beat frequency signals output by a frequency mixer, an energy peak of the beat frequency signal output by the frequency mixer based on the local signal 2 and the received echo signal of the signal 2 falls within a passband of a low-pass filter, and an energy peak of the beat frequency signal output by the frequency mixer based on the local signal 2 and the received echo signal of the signal 1 falls within a stopband of the low-pass filter.

It may be understood that if the difference between the time shifts of the signal 1 and the signal 2 is increased, interference between the signal 1 and the signal 2 is also zero. A smaller difference between time shifts indicates a larger quantity of apparatuses that can share a same resource. Therefore, a difference between time shifts of FMCW signals of two apparatuses may be designed to be τₘₐₓ, so that a maximum multiplexing quantity that can be supported when the shift multiplexing mode is used is └T/τₘₐₓ┘. The term └T/τₘₐₓ┘ may also be referred to as a maximum multiplexing quantity supported by shift multiplexing.

In a possible design, in a plurality of second apparatuses sharing a same time-frequency resource, a time shift τₙ of the n^{th} second apparatus meets the following condition: τₙ=(n−1)τₘₐₓ, where n=1, 2, . . . , └T/τₘₐₓ┘. A value of T may be predefined in a protocol or indicated by the first apparatus. This is not limited in this application.

For example, FIG. 8 is a diagram of a plurality of FMCW signals with different time shifts according to an embodiment of this application. FIG. 8 shows FMCW signals transmitted by five second apparatuses. Different types of lines represent FMCW signals transmitted by different second apparatuses. A time shift of a signal 5 is 0. A time shift of a signal 1 is τₘₐₓ. A time shift of a signal 2 is 2 τₘₐₓ. A time shift of a signal 3 is 3 τₘₐₓ. A time shift of a signal 4 is 4τₘₐₓ. The five second apparatuses periodically transmit the FMCW signals based on the foregoing time shifts, so that a time-frequency relationship diagram shown in FIG. 8 may be obtained. In this example, the FMCW signals transmitted by the second apparatuses are evenly arranged in time. Here, a transmission time interval between two adjacent FMCW signals is τₘₐₓ. A transmission time interval between any two FMCW signals is an integer multiple of τₘₐₓ.

In an example, it is assumed that the time shift is τₘₐₓ, and τₘₐₓ is 10 microseconds (μs). A transmission time of the signal 5 is 10 us later than a transmission time of the signal 4. The transmission time of the signal 4 is 10 us later than a transmission time of the signal 3. The transmission time of the signal 3 is 10 us later than a transmission time of the signal 2. The transmission time of the signal 2 is 10 us later than a transmission time of the signal 1. In this way, the time-frequency relationship diagram shown in FIG. 8 may be obtained.

In a possible implementation, the time shift may be at a microsecond level. The time shift may alternatively be at another level. This is not limited in this application.

A smaller difference between time shifts indicates a larger quantity of radars that can share a same resource. Therefore, a minimum difference between time shifts of FMCW signals of a plurality of second apparatuses is designed to be τₘₐₓ, so that a multiplexing quantity that can be supported when the shift multiplexing mode is used alone can reach a maximum value. When the multiplexing quantity is small, the time shift of each second apparatus may alternatively be set to a value greater than τₘₐₓ.

A smaller time shift indicates a smaller interval between two adjacent FMCW signals. Within a same period of time, a plurality of second apparatuses can transmit more FMCW signals, which is more conducive to obtaining more data and providing richer data for measurement.

The foregoing formulas 1 and 2 are merely examples. A person skilled in the art may make simple transformations on them, for example, select different plus-minus sign for slopes or introduce phase coding.

The following provides several possible variations as examples. However, it should be understood that these variations are merely examples, and there may be other variations. This is not limited in this application.

### Variation 1:

$${s}_{1} ( t ) = rect ( \frac{t - {τ}_{1} - T / 2}{T} ) {e}^{j 2 [ ( {f}_{c} - kT / 2 ) ( t - {τ}_{1} ) + {k ( t - {τ}_{1} )}^{2} / 2 ]} \qquad Formula 1 - 2$$

$${s}_{2} ( t ) = rect ( \frac{t - {τ}_{2} - T / 2}{T} ) {e}^{j 2 [ ( {f}_{c} + kT / 2 ) ( t - {τ}_{2} ) + {k ( t - {τ}_{2} )}^{2} / 2 ]} \qquad Formula 2 - 2$$

$$Variation 2 :$$

$${s}_{1} ( t ) = rect ( \frac{t - {τ}_{1} - T / 2}{T} ) c ( t - {τ}_{1} ) {e}^{j 2 [ ( {f}_{c} + kT / 2 ) ( t - {τ}_{1} ) - {k ( t - {τ}_{1} )}^{2} / 2 ]} \qquad Formula 1 - 3$$

$${s}_{2} ( t ) = rect ( \frac{t - {τ}_{2} - T / 2}{T} ) c ( t - {τ}_{2} ) {e}^{j 2 [ ( {f}_{c} - kT / 2 ) ( t - {τ}_{2} ) + {k ( t - {τ}_{2} )}^{2} / 2 ]} \qquad Formula 2 - 3$$

In these equations c(t) is a function of phase coding, which meets the following condition:

$$c ( t ) = {\sum }_{l = 1}^{T / {T}_{2}} {c}_{l} rect ( \frac{t - {lT}_{c} / 2}{{T}_{c}} ) .$$

The variable T_{c} is a chip period of phase coding, cₗ is a phase coding sequence, and l=0, 1, . . . , T/T_{c}. The phase coding sequence is described in detail in related content of phase coding multiplexing, and is not described in detail herein.

More possible variations may be obtained with reference to the foregoing formulas 1-1 and 1-2 to which the reference time to is added, and are not enumerated herein.

2. Conjugate symmetric multiplexing: A same time-frequency resource is shared by two conjugate symmetric FMCW signals. In embodiments of this application, conjugate symmetry is specific to a slope of an FMCW signal. It should be understood that the two FMCW signals are signals from different second apparatuses.

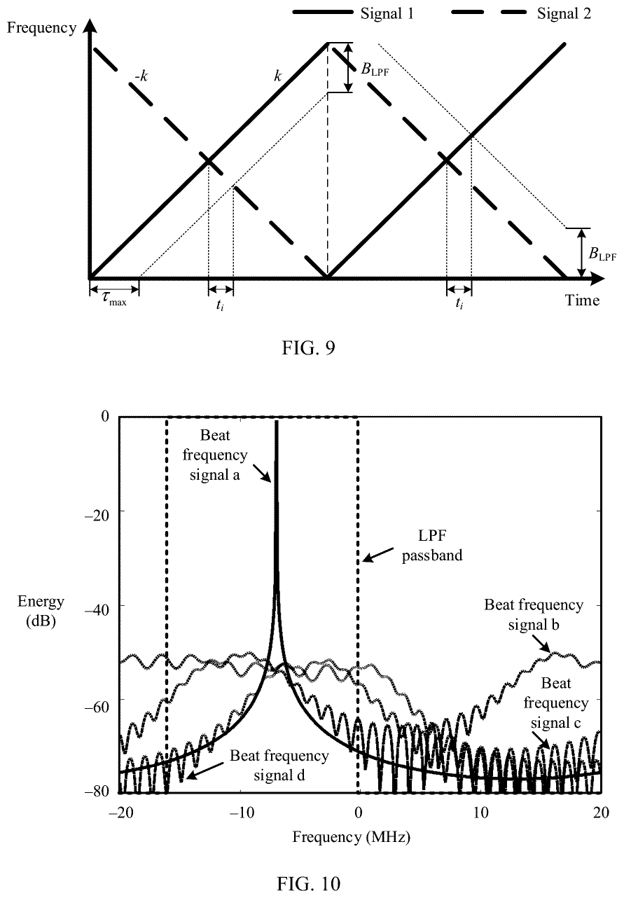

FIG. 9 is another diagram of FMCW signals transmitted by two second apparatuses according to an embodiment of this application. The two second apparatuses may be denoted as an apparatus 1 and an apparatus 2. The FMCW signal transmitted by the apparatus 1 is denoted as a signal 1 and denoted as s₁(t). The FMCW signal transmitted by the apparatus 2 is denoted as a signal 2 and denoted as s₂(t). The signal 1 and the signal 2 are respectively expressed as the following formulas 3 and 4:

$${s}_{1} ( t ) = rect ( \frac{t - T / 2}{T} ) {e}^{j 2 π [ ( {f}_{c} - kT / 2 ) t + {kt}^{2} / 2 ]} \qquad Formula 3$$

$${s}_{2} ( t ) = rect ( \frac{t - T / 2}{T} ) {e}^{j 2 π [ ( {f}_{c} + kT / 2 ) t - {kt}^{2} / 2 ]} \qquad Formula 4$$

It is noted that the time shifts of the FMCW signals transmitted by the two second apparatuses are both zero. In other words, the transmission times of the FMCW signals are the same. In addition, the slopes are both k, and phase coding is not performed.

FIG. 9 shows a time-frequency relationship between the signal 1 and the signal 2. It can be learned that the signal 1 and the signal 2 occupy same bandwidth in the frequency domain and are transmitted at the same time, but the plus-minus signs of their slopes are opposite.

FIG. 10 is a diagram of interference levels of a plurality of groups of conjugate symmetric FMCW signals according to an embodiment of this application. Slopes of FMCW signals in each group are the same, while slopes of FMCW signals in different groups are different. There are the following three groups of signals: a signal 1a with a slope of +8 megahertz (MHz)/μs and a signal 1b with a slope of −8 MHz/μs; a signal 2a with a slope of +10 MHz/μs and a signal 2b with a slope of −10 MHz/μs; and a signal 3a with a slope of +13.8 MHz/μs and a signal 3b with a slope of −13.8 MHz/μs. Energy of beat frequency signals is shown in FIG. 10.

The group of the signal 1a and the signal 1b is used as an example. After echo signals of the signal 1a and the signal 1b are received by a second apparatus from which the signal 1a eminates, a frequency mixer may output beat frequency signals based on the locally generated signal 1a and the received echo signals of the signal 1a and the signal 1b. The frequency mixer outputs a beat frequency signal a based on the locally generated signal 1a and the received echo signal of the signal 1a. The frequency mixer outputs a beat frequency signal b based on the locally generated signal 1a and the received echo signal of the signal 1b. An energy peak of the beat frequency signal a is obvious and falls within a passband of a low-pass filter. An energy peak of the beat frequency signal b is not obvious and exists in the passband of the low-pass filter with non-zero energy, and interference may be caused by the beat frequency signal a. However, the interference is small.

Similarly, after echo signals of the signal 2a and the signal 2b are received by a second apparatus from which the signal 2a eminates, in beat frequency signals output by a frequency mixer, an energy peak of the beat frequency signal (as shown by the beat frequency signal a in the figure) output by the frequency mixer based on the local signal 2a and the received echo signal of the signal 2a is obvious and falls within a passband of a low-pass filter. An energy peak of the beat frequency signal (as shown by the beat frequency signal c in the figure) output by the frequency mixer based on the local signal 2a and the received echo signal of the signal 2b is not obvious and exists in the passband of the low-pass filter with non-zero energy, and interference may be caused. However, the interference is small.

After echo signals of the signal 3a and the signal 3b are received by a second apparatus from which the signal 3a eminates, in beat frequency signals output by a frequency mixer, an energy peak of the beat frequency signal (as shown by the beat frequency signal a in the figure) output by the frequency mixer based on the local signal 3a and the received echo signal of the signal 3a is obvious and falls within a passband of a low-pass filter. An energy peak of the beat frequency signal (as shown by a beat frequency signal d in the figure) output by the frequency mixer based on the local signal 3a and the received echo signal of the signal 3b is not obvious and exists in the passband of the low-pass filter with non-zero energy, and interference may be caused. However, the interference is small.

Although not shown in the figure, it can be inferred that if the echo signals of the signal 1a and the signal 1b are received by a second apparatus from which the signal 1b eminates, in beat frequency signals output by a frequency mixer, an energy peak of the beat frequency signal output by the frequency mixer based on the local signal 1b and the received echo signal of the signal 1b falls within a passband of a low-pass filter. An energy peak of the beat frequency signal output by the frequency mixer based on the local signal 1b and the received echo signal of the signal 1a is not obvious, and interference is small. By analogy, examples are not described one by one herein.

FIG. 9 further shows a duration tᵢ for which the signal 1 is interfered with by the signal 2 and a duration tᵢ for which the signal 2 is interfered with by the signal 1 (referred to as interference duration for short below). It can be seen that the interference duration is the same, which is τₘₐₓ/2. In addition, an interference energy spectral density is as follows: I=1/[k−(−k)]=1/(2k). Signal-to-Interference ratios of the signal 1 and the signal 2 generated based on the conjugate symmetric multiplexing mode are as follows: S/I=2B²/k, where I=1/(2k). Powers S of the signal 1 and the signal 2 may be obtained based on the duration T. S and T may meet the following condition: S=T². T=B²/k². Therefore, S=B²/k² may be obtained. An interference level between the signal 1 and the signal 2 may be obtained as k/(2B²) based on the signal-to-interference ratios.

It can be learned from the foregoing description with reference to FIG. 9 and FIG. 10 that when the signal 1 and the signal 2 are conjugate symmetric, interference between them can be suppressed to some extent. Therefore, this mode may also be used as a multiplexing mode. Because conjugate symmetry usually involves signals transmitted by two second apparatuses, a multiplexing quantity that can be supported by conjugate symmetric multiplexing is 2.

Further, if conjugate symmetric multiplexing is combined with another multiplexing mode, a maximum multiplexing quantity may be multiplied. For example, in combination with shift multiplexing, the maximum multiplexing quantity that can be supported is 2└T/τₘₐₓ┘.

Compared with conjugate symmetric multiplexing, shift multiplexing can reduce interference between signals to almost zero. Therefore, if a multiplexing quantity is small, for example, less than or equal to └T/τₘₐₓ┘, shift multiplexing is preferentially used. If a multiplexing quantity is large, for example, greater than └T/τₘₐₓ┘, shift multiplexing and max conjugate symmetric multiplexing are used in combination.

In a possible design, if a multiplexing quantity N is less than or equal to └T/τₘₐₓ┘, the target multiplexing mode includes shift multiplexing. If the multiplexing quantity N is greater than └T/τₘₐₓ┘ and less than or equal to 2└T/τₘₐₓ┘, the target multiplexing mode includes shift multiplexing and conjugate symmetric multiplexing.

For example, if the multiplexing quantity N is greater than max and less than or equal to 2└T/τₘₐₓ┘, every two second apparatuses may be taken as one group. A time shift τₙ of an n^{th} group of second apparatuses meets the following condition: τₙ=(n−1)τₘₐₓ, where n=1, 2, . . . , └T/τₘₐₓ┘. Signals of each group of second apparatuses are conjugate symmetric. If the multiplexing quantity Nis an even number, a plurality of groups of second apparatuses may be obtained through combination. If the multiplexing quantity Nis an odd number, in addition to a plurality of groups of second apparatuses obtained through combination, one second apparatus may be separately taken as one group and allocated a time shift. Specifically, the time shift may also be determined based on the foregoing formula, and details are not described again.

The foregoing formulas 3 and 4 are merely examples. A person skilled in the art may make simple transformations on them, for example, introduce a time shift and/or phase coding.

The following provides several possible variations as examples. However, these variations are merely examples, and there may be other variations. This is not limited in this application.

### Variation 1:

$${s}_{1} ( t ) = rect ( \frac{t - τ - T / 2}{T} ) {e}^{j 2 π [ ( {f}_{c} + kT / 2 ) ( t - τ ) - {k ( t - τ )}^{2} / 2 ]} \qquad Formula 3 - 1$$

$${s}_{2} ( t ) = rect ( \frac{t - τ - T / 2}{T} ) {e}^{j 2 π [ ( {f}_{c} - kT / 2 ) ( t - τ ) + {k ( t - τ )}^{2} / 2 ]} \qquad Formula 4 - 1$$

τ is a time shift.

### Variation 2:

$${s}_{1} ( t ) = rect ( \frac{t - T / 2}{T} ) c ( t ) {e}^{j 2 π [ ( {f}_{c} + kT / 2 ) t - {k}^{2} / 2 ]} \qquad Formula 3 - 2$$

$${s}_{2} ( t ) = rect ( \frac{t - T / 2}{T} ) c ( t ) {e}^{j 2 π [ ( {f}_{c} - kT / 2 ) t + {k}^{2} / 2 ]} \qquad Formula 4 - 2$$

### Variation 3:

$${s}_{1} ( t ) = rect ( \frac{t - τ - T / 2}{T} ) c ( t - τ ) {e}^{j 2 [ ( {f}_{c} + kT / 2 ) ( t - τ ) - {k ( t - {τ}_{1} )}^{2} / 2 ]} \qquad Formula 3 - 3$$

$${s}_{2} ( t ) = rect ( \frac{t - τ - T / 2}{T} ) c ( t - {τ}_{2} ) {e}^{j 2 [ ( {f}_{c} - kT / 2 ) ( t - τ ) + {k ( t - {τ}_{2} )}^{2} / 2 ]} \qquad Formula 4 - 3$$

In the variations 2 and 3, c(t) is a function of phase coding. For details, refer to the foregoing related descriptions. Details are not described again.

In the foregoing, several possible variations may be used in combination or separately provided that there is no conflict, and more possible variations may be obtained when they are used in combination. In addition, a person skilled in the art may further convert the time shift into a frequency shift, or combine conjugate symmetric multiplexing with another multiplexing mode (for example, slope multiplexing), to obtain other possible variations, which are not enumerated herein.

3. Slope multiplexing: A same time-frequency resource is shared by a plurality of FMCW signals generated based on different slopes. Each FMCW signal corresponds to one slope. It should be understood that the plurality of FMCW signals are signals from different second apparatuses.

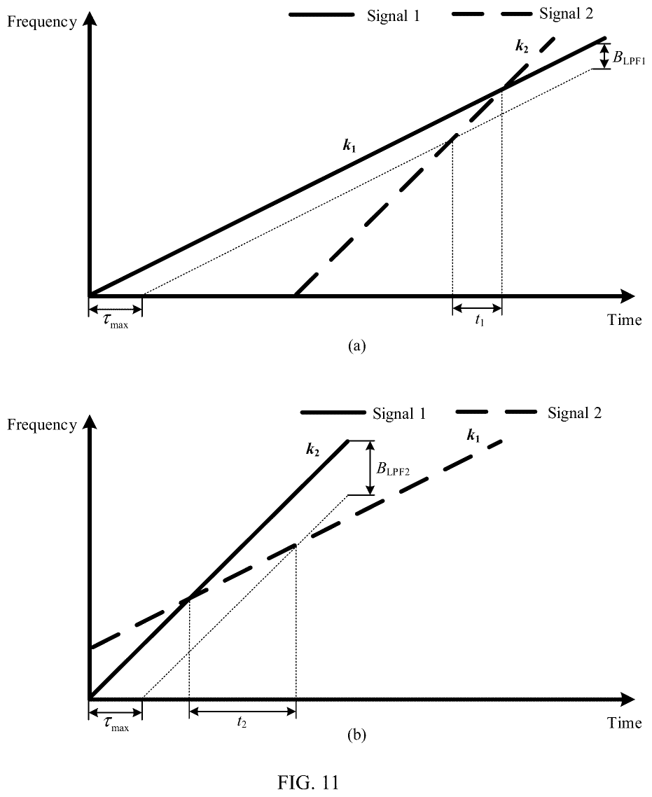

FIG. 11 is still another diagram of FMCW signals transmitted by two second apparatuses according to an embodiment of this application. The two second apparatuses are denoted as an apparatus 1 and an apparatus 2. The FMCW signal transmitted by the apparatus 1 is denoted as a signal 1 and denoted as s₁(t). The FMCW signal transmitted by the apparatus 2 is denoted as a signal 2 and denoted as s₂(t). The signal 1 and the signal 2 are respectively expressed as the following formulas 5 and 6:

$${s}_{1} ( t ) = rect ( \frac{t - {τ}_{1} - T / 2}{T} ) {e}^{j 2 [ ( {f}_{c} - {k}_{1} T / 2 ) ( t - {τ}_{1} ) + {{k}_{1} ( t - {τ}_{1} )}^{2} / 2 ]} \qquad Formula 5$$

$${s}_{2} ( t ) = rect ( \frac{t - {τ}_{2} - T / 2}{T} ) {e}^{j 2 [ ( {f}_{c} - {k}_{2} T / 2 ) ( t - {τ}_{2} ) + {{k}_{2} ( t - {τ}_{2} )}^{2} / 2 ]} \qquad Formula 6$$

Slopes of the FMCW signals transmitted by the two second apparatuses are respectively k₁ and k₂, time shifts are respectively τ₁ and τ₂, and phase coding is not performed.

FIG. 11 shows a time-frequency relationship between the signal 1 and the signal 2. The slope k₁ of the signal 1 is less than the slope k₂ of the signal 2. Therefore, a duration of the signal 1 is different from that of the signal 2. The duration of the signal 1 is longer than that of the signal 2.

In FIG. 11, (a) shows interference from the signal 2 to the signal 1. In a range of a passband bandwidth (B_{LPF1}) of a low-pass filter for the signal 1, the signal 2 interferes with the signal 1 in a range of τ₁. In FIG. 11, (b) shows interference from the signal 1 to the signal 2. In a range of a passband bandwidth (B_{LPF2}) of a low-pass filter for the signal 2, the signal 1 interferes with the signal 2 in a range of 12. Time shifts of the signal 1 shown in (a) and (b) in FIG. 11 are different. Time shifts of the signal 2 shown in (a) and (b) in FIG. 11 may be the same. The figure is merely for ease of showing the interference from the signal 2 to the signal 1 and the interference from the signal 1 to the signal 2, and the time shifts of the signal 1 and the signal 2 are not limited.

Table 1 shows parameters of the interference from the signal 2 to the signal 1 and parameters of the interference from the signal 1 to the signal 2.

TABLE 1

| | Parameters of the | Parameters of the |
|---|---|---|
| | interference | interference |
| | from the signal 2 | from the signal 1 |
| | to the signal 1 | to the signal 2 |
| Signal power | S₁ = T₁² | S₂ = T₂² |
| Interference duration | t₁ = k₁τₘₐₓ/(k₂ − k₁) | t₂ = k₂τₘₐₓ/(k₂ − k₁) |
| Passband bandwidth of | B_{LPF1} = k₁τₘₐₓ | B_{LPF2} = k₂τₘₐₓ |
| the low-pass filter | | |
| Interference spectral | I₁ = 1/(k₂ − k₁) | I₂ = 1/(k₂ − k₁) |
| density | | |
| Signal-to-Interference | S₁/I₁ = B²(k₂ − k₁)/k₁² | S₂/I₂ = B²(k₂ − k₁)/k₂² |
| ratio | | |

The subscripts “1” and “2” of the parameters in Table 1 respectively correspond to the signal 1 and the signal 2. For example, S₁ represents power of the signal 1, and S₂ represents power of the signal 2. T₁ represents the duration of the signal 1, and T₂ represents the duration of the signal 2. B_{LPF1} represents the passband bandwidth of a low-pass filter of the apparatus 1 from which the signal 1 eminates, and B_{LPF2} represents the passband bandwidth of a low-pass filter of the apparatus 2 from which the signal 2 eminates. The rest may be deduced by analogy, and details are not described again.

In addition, in Table 1, for the signal 1, interference is interference caused by the signal 2 to the signal 1. For the signal 2, interference is interference caused by the signal 1 to the signal 2. The interference spectral density I₁ and the signal-to-interference ratio S₁/I₁ are calculated based on the interference caused by the signal 2 to the signal 1. The interference spectral density I₂ and the signal-to-interference ratio S₂/I₂ are calculated based on the interference caused by the signal 1 to the signal 2.

Although not shown in Table 1, it may be deduced that if an FMCW signal (for example, denoted as a signal 3) whose slope is k₃ eminates from another second apparatus, and k₃ is greater than k₂: Based on interference caused by the signal 3 to the signal 1, it may be calculated that an interference spectral density of the signal 1 is 1/(k₃−k₁), and a signal-to-interference ratio is B²(k₃−k₁)/k₁². Based on interference caused by the signal 1 to the signal 3, it may be calculated that an interference spectral density of the signal 3 is 1/(k₃−k₁), and a signal-to-interference ratio is B²(k₃−k₁)/k₃². By analogy, an interference spectral density and a signal-to-interference ratio of the signal 2 may be calculated based on interference caused by the signal 3 to the signal 2, and an interference spectral density and a signal-to-interference ratio of the signal 3 may be calculated based on interference caused by the signal 2 to the signal 3. Details are not listed herein one by one.

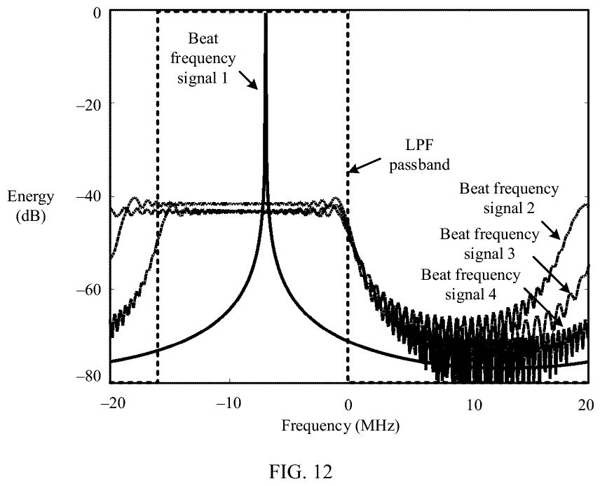

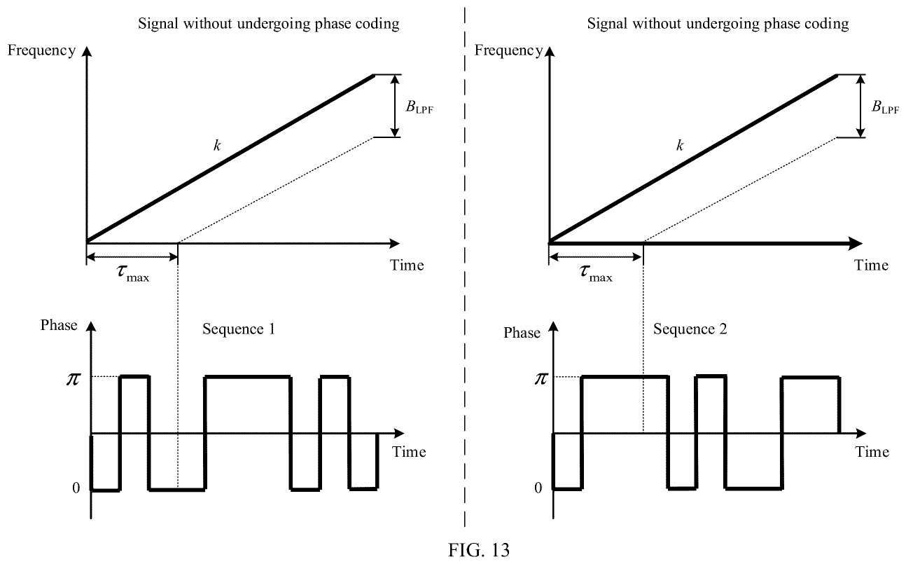

FIG. 12 is a diagram of interference levels of four FMCW signals with different slopes according to an embodiment of this application. FIG. 12 shows a case in which an FMCW signal (denoted as a signal a) whose slope is 10 MHz/μs is interfered by FMCW signals (denoted as a signal b, a signal c, and a signal d) whose slopes are respectively 8 MHz/μs, 12 MHz/μs, and 13.8 MHz/μs. After an echo signal a′ of the signal a, an echo signal b′ of the signal b, an echo signal c′ of the signal c, and an echo signal d′ of the signal d are received by a second apparatus from which the signal a eminates, a frequency mixer may output beat frequency signals based on the locally generated signal a and the received echo signals a′, b′, c′, and d′. The frequency mixer outputs a beat frequency signal 1 based on the locally generated signal a and the received echo signal a′. The frequency mixer outputs a beat frequency signal 2 based on the locally generated signal a and the received echo signal b′. The frequency mixer outputs a beat frequency signal 3 based on the locally generated signal a and the received echo signal c′. The frequency mixer outputs a beat frequency signal 4 based on the locally generated signal a and the received echo signal d′. An energy peak of the beat frequency signal 1 is obvious and falls within a passband of a low-pass filter. Energy peaks of the beat frequency signals 2, 3, and 4 exist in the passband of the low-pass filter, and specific interference may be caused by the beat frequency signal 1. However, because the energy peaks of the beat frequency signals 2, 3, and 4 are far lower than the energy peak of the beat frequency signal 1, the interference to the beat frequency signal 1 is small.

Similarly, if the echo signals a′, b′, c′, and d′ are received by a second apparatus from which the signal b eminates, interference caused by the echo signals a′, c′, and d′ to the signal b is also small. If the echo signals a′, b′, c′, and d′ are received by a second apparatus from which the signal c eminates, interference caused by the echo signals a′, b′, and d′ to the signal c is also small. If the echo signals a′, b′, c′, and d′ are received by a second apparatus from which the signal d eminates, interference caused by the echo signals a′, b′, and c′ to the signal d is also small. For brevity, details are not described herein.

It can be found through comparison that FMCW signals with different slopes transmitted by a plurality of second apparatuses have the following rules:
(1) The closer the slopes, the larger interference between the signals. Therefore, the closer two slopes, the larger interference between generated FMCW signals.
(2) Interference from an FMCW signal generated with a large slope to an FMCW signal generated with a small slope is always less than interference from the FMCW signal generated with the small slope to the FMCW signal generated with the large slope.

For example, in the foregoing example, interference between the signal 1 and the signal 2 is greater than interference between the signal 1 and the signal 3, and the interference from the signal 1 to the signal 2 is greater than the interference from the signal 2 to the signal 1.

If minimum signal-to-interference ratios of the second apparatuses can be aligned, maximum possible interference can also be aligned, so that interference between the signals of the plurality of second apparatuses can be controlled within a specific range.

If slopes of m FMCW signals with different slopes are denoted as k₁, k₂, . . . , and kₘ, where k₁<k₂< . . . <kₘ₋₁<kₘ. In a possible design,

$$\frac{{k}_{2} - {k}_{1}}{{k}_{2}^{2}} = \frac{{k}_{3} - {k}_{2}}{{k}_{3}^{2}} = … = \frac{{k}_{m} - {k}_{m - 1}}{{k}_{m}^{2}} = q ,$$

where q is a predefined value. Therefore, it may be obtained that the slope of the signal 1 is k₁, the slope of the signal 2 is

$${k}_{2} = \frac{1 - \sqrt{1 - 4 {qk}_{1}}}{2 q} ,$$

the slope of the signal 3 is

$${k}_{3} = \frac{1 - \sqrt{1 - 4 {qk}_{2}}}{2 q} ,$$

and the slope of the signal m is

$${k}_{m} = \frac{1 - \sqrt{1 - 4 {qk}_{m - 1}}}{2 q}$$

by analogy, where k₁<k₂< . . . <kₘ₋₁<1/(4q)<kₘ<1/(2q). Based on

$$\frac{{k}_{2} - {k}_{1}}{{k}_{2}^{2}} = \frac{{k}_{3} - {k}_{2}}{{k}_{3}^{2}} = … = \frac{{k}_{m} - {k}_{m - 1}}{{k}_{m}^{2}} = q$$

and the signal-to-interference ratio calculated in Table 1, the signal-to-interference ratio may be further simplified to B²q, and a corresponding interference level is 1/(B²q).

The value of q affects the signal-to-interference ratio and the interference level. A larger value of q indicates a larger signal-to-interference ratio and a smaller interference. A smaller value of q indicates a smaller signal-to-interference ratio and a larger interference. Therefore, the value of q may be adjusted based on an actual requirement for detection precision of the second apparatus. In addition, the value of q affects a maximum multiplexing quantity supported by slope multiplexing. A larger value of q indicates a smaller maximum multiplexing quantity that can be supported by slope multiplexing.

Moreover, a larger slope difference between two FMCW signals indicates longer duration of one of the FMCW signals, which affects a transmission period of the other FMCW signal. For example, a transmission period of an FMCW signal is a duration of an FMCW signal with a minimum slope in a plurality of FMCW signals with different slopes. Therefore, when the slope multiplexing mode is used, a difference between a maximum slope and a minimum slope may be limited, to avoid that a signal transmission period is excessively long due to an excessively long duration of an FMCW signal, and a surrounding environment cannot be detected in time.

In the event that an FMCW signal is transmitted discontinuously, a duration T of the FMCW signal is not necessarily equal to a transmission period of the FMCW signal. The transmission period is a minimum interval for repeatedly transmitting the FMCW signal, and may be greater than or equal to the duration of the FMCW signal.

In the m FMCW signals with different slopes, the difference between the maximum slope and the minimum slope is as follows: Δk=kₘ−k₁. A value of Δk is predefined, so that a difference between slopes can be controlled within a specific range, to avoid an excessively long duration of an FMCW signal.

Based on the predefined values of q and Δk, it may be calculated that the maximum multiplexing quantity that can be supported by slope multiplexing is 2/(1−4q²Δk)

Further, if slope multiplexing is combined with another multiplexing mode, a maximum multiplexing quantity may be multiplied. For example, if slope multiplexing is combined with shift multiplexing, the maximum multiplexing quantity that can be supported is └T/τₘₐₓ┘└2/(1−4q²Δk)┘. If slope multiplexing is combined with conjugate symmetric multiplexing, the maximum multiplexing quantity that can be supported is └2/(1−4q²Δk)┘. If slope multiplexing is combined with shift multiplexing and conjugate symmetric multiplexing, the maximum multiplexing quantity that can be supported is 2└T/τₘₐₓ┘└2/(1−4q²Δk)┘. By analogy, if slope multiplexing is combined with any one or more multiplexing modes, the maximum multiplexing quantity that can be supported is a product of the maximum multiplexing quantities that can be supported by the plurality of multiplexing modes used in combination.

Simulation results show that conjugate symmetric multiplexing has a signal-to-interference ratio gain of at least 3 dB compared with slope multiplexing. An interference level of conjugate symmetric multiplexing is lower than that of slope multiplexing. An interference level of shift multiplexing is lower than that of conjugate symmetric multiplexing. Therefore, if a multiplexing quantity is small, for example, less than or equal to └T/tₘₐₓ┘, shift multiplexing may be preferentially used. If a multiplexing quantity is large, conjugate symmetric multiplexing and/or slope multiplexing are used in combination. For example, as the multiplexing quantity increases, conjugate symmetric multiplexing and slope multiplexing are sequentially used in combination.

In a possible design, if a multiplexing quantity N is less than or equal to └T/τₘₐₓ┘, the target multiplexing mode includes shift multiplexing. If the multiplexing quantity N is greater than └T/τₘₐₓ┘ and less than or equal to 2└T/τₘₐₓ┘, the target multiplexing mode includes shift multiplexing and conjugate symmetric multiplexing. If the multiplexing quantity N is greater than 2└T/τₘₐₓ┘ and less than or equal to 2└T/τₘₐₓ┘└2/(1−4q²Δk)┘, the target multiplexing mode includes shift multiplexing, conjugate symmetric multiplexing, and slope multiplexing.

The foregoing formulas 5 and 6 are merely examples. A person skilled in the art may make simple transformations on them, for example, introduce no time shift, introduce a same time shift, or introduce phase coding.

The following provides several possible variations as examples. However, it should be understood that these variations are merely examples, and there may be other variations. This is not limited in this application.

### Variation 1:

$${s}_{1} ( t ) = rect ( \frac{t - T / 2}{T} ) {e}^{j 2 π [ ( {f}_{c} - {k}_{1} T / 2 ) t - {k}_{1} {t}^{2} / 2 ]} \qquad Formula 5 - 1$$

$${s}_{2} ( t ) = rect ( \frac{t - T / 2}{T} ) {e}^{j 2 π [ ( {f}_{c} - {k}_{2} T / 2 ) t - {k}_{2} {t}^{2} / 2 ]} \qquad Formula 6 - 1$$

### Variation 2:

$${s}_{1} ( t ) = rect ( \frac{t - τ - T / 2}{T} ) {e}^{j 2 [ ( {f}_{c} + {k}_{1} T / 2 ) ( t - τ ) - {{k}_{1} ( t - τ )}^{2} / 2 ]} \qquad Formula 5 - 2$$

$${s}_{2} ( t ) = rect ( \frac{t - τ - T / 2}{T} ) {e}^{j 2 [ ( {f}_{c} + {k}_{2} T / 2 ) ( t - τ ) - {{k}_{2} ( t - τ )}^{2} / 2 ]} \qquad Formula 6 - 2$$

where τ is a time shift.

### Variation 3:

$${s}_{1} ( t ) = rect ( \frac{t - T / 2}{T} ) c ( t ) {e}^{j 2 π [ ( {f}_{c} + {k}_{1} T / 2 ) t - {k}_{1} {t}^{2} / 2} \qquad Formula 5 - 3$$

$${s}_{2} ( t ) = rect ( \frac{t - T / 2}{T} ) c ( t ) {e}^{j 2 π [ ( {f}_{c} + {k}_{2} T / 2 ) t - {k}_{2} {t}^{2} / 2} \qquad Formula 6 - 3$$

### Variation 4:

$${s}_{1} ( t ) = rect ( \frac{t - τ - T / 2}{T} ) c ( t - τ ) {e}^{j 2 π [ ( {f}_{c} + kT / 2 ) ( t - τ ) - {k ( t - τ )}^{2} / 2 ]} \qquad Formula 5 - 4$$

$${s}_{2} ( t ) = rect ( \frac{t - τ - T / 2}{T} ) c ( t - τ ) {e}^{j 2 π [ ( {f}_{c} + kT / 2 ) ( t - τ ) + {k ( t - τ )}^{2} / 2 ]} \qquad Formula 6 - 4$$

where c(t) is a function of phase coding. For details, refer to the foregoing related descriptions. Details are not described again.

The foregoing several possible variations may be used in combination or separately provided that there is no conflict, and more possible variations may be obtained when they are used in combination. In addition, a person skilled in the art may further convert the time shift into a frequency shift, or combine slope multiplexing with another multiplexing mode (for example, conjugate symmetric multiplexing), to obtain other possible variations, which are not enumerated herein.

4. Phase coding multiplexing: A same time-frequency resource is shared by a plurality of FMCW signals generated through phase coding based on coding parameters with different values. Each FMCW signal corresponds to a value of a coding parameter. It should be understood that the plurality of FMCW signals are signals from different second apparatuses.

As described above, a function c(t) of phase coding meets the following condition:

$$c ( t ) = {\sum }_{l = 1}^{T / {T}_{c}} {c}_{l} rect ( \frac{t - l {T}_{c} / 2}{{T}_{c}} ) ,$$

where cₗ is a phase coding sequence. To distinguish coding parameters of different phase coding, phase coding may be distinguished by using a subscript r, to obtain

$$c ( t ) = {\sum }_{l = 1}^{T / {T}_{c}} {c}_{r , l} rect ( \frac{t - l {T}_{c} / 2}{{T}_{c}} ) ,$$

where r=0, 1, . . . , N_{ZC}−1.

The following provides two possible phase coding sequences as examples.

In a possible design, the phase coding sequence is a ZC sequence. The coding parameter for the phase coding is a root sequence index of the ZC sequence. Each FMCW signal may correspond to one root sequence index. Different FMCW signals correspond to different root sequence indexes.

A person skilled in the art may understand that the ZC sequence z, meets the following condition z_{r,l}=e^{-jπrl(l+1)/N}^{_{ZC}}, where r is a root sequence index, and r=1, 2, . . . , N_{ZC}−1. N_{ZC} represents a total length of the ZC sequence, and/represents an index value of the ZC sequence.

In embodiments of this application, the coding parameter for the phase coding may correspond to the root sequence index r in the ZC sequence. Different FMCW signals correspond to different index values. A value range (1 to N_{ZC}−1) of r is related to a maximum multiplexing quantity that can be supported when the ZC sequence is used as the phase coding sequence. In other words, a value of N_{ZC} is related to the maximum multiplexing quantity that can be supported when the ZC sequence is used as the phase coding sequence.

To ensure that the signal can pass through the low-pass filter without distortion, a chip length T_{c} should meet the following condition: T_{c}≥T/Bτₘₐₓ. Therefore, when T_{c}=T/Bτₘₐₓ, a maximum length of the ZC sequence may be obtained as T/T_{c}=Bτₘₐₓ. When the ZC sequence is used as the phase coding sequence, the maximum multiplexing quantity that can be achieved is └Bτₘₐₓ┘−1. When the ZC sequence is used as the phase coding sequence, the value range of r is 1 to └Bτₘₐₓ┘−1. A signal-to-interference ratio is Bτₘₐₓ. An interference level is 1/(Bτₘₐₓ).

Based on the foregoing analysis, a phase coding sequence used to generate an FMCW signal may be obtained as follows:

$${c}_{r , l} = {e}^{- j π rl ( l + 1 ) / ⌊ B {τ}_{max} ⌋} , r = 1 , 2 , … , ⌊ B {τ}_{max} ⌋ - 1.$$

Therefore, an FMCW signal to which phase coding is introduced may be expressed as the following formula 7 or 8:

$$s ( t ) = rect ( \frac{t - T / 2}{T} ) c ( t ) {e}^{j 2 π [ ( {f}_{c} + kT / 2 ) t - {kt}^{2} / 2 ]} , \qquad Formula 7$$

$$c ( t ) = {\sum }_{l = 1}^{T / {T}_{c}} {c}_{r , l} rect ( \frac{t - l {T}_{c} / 2}{{T}_{c}} ) , r = 1 , 2 , … , ⌊ B {τ}_{max} ⌋ - 1$$

$$s ( t ) = rect ( \frac{t - T / 2}{T} ) c ( t ) {e}^{j 2 π [ ( {f}_{c} - kT / 2 ) t + {kt}^{2} / 2 ]} , \qquad Formula 8$$

$$c ( t ) = {\sum }_{l = 1}^{T / {T}_{c}} {c}_{r , l} rect ( \frac{t - l {T}_{c} / 2}{{T}_{c}} ) , r = 1 , 2 , … , ⌊ B {τ}_{max} ⌋ - 1$$

If different second apparatuses use different coding parameters, for example, one second apparatus uses r₁ to generate a phase coding sequence c₁(t) of an FMCW signal, and another second apparatus uses r₂ to generate a phase coding sequence c₂(t) of an FMCW signal, c₁(t) and c₂(t) may be obtained as follows:

$${c}_{1} ( t ) = {\sum }_{l = 1}^{T / {T}_{c}} {c}_{{r}_{1} , l} rect ( \frac{t - l {T}_{c} / 2}{{T}_{c}} ) , {c}_{{r}_{1} , l} = {e}^{j π {r}_{1} l ( l + 1 ) / ⌊ B {τ}_{max} ⌋}$$

$${c}_{2} ( t ) = {\sum }_{l = 1}^{T / {T}_{c}} {c}_{{r}_{2} , l} rect ( \frac{t - l {T}_{c} / 2}{{T}_{c}} ) , {c}_{{r}_{2} , l} = {e}^{j π {r}_{2} l ( l + 1 ) / ⌊ B {τ}_{max} ⌋}$$

For ease of understanding only, the foregoing describes, by using two second apparatuses as an example, different coding parameters allocated to different second apparatuses, and root sequences obtained based on the different coding parameters and used to generate FMCW signals. However, this shall not constitute any limitation on this application. If there is another quantity of second apparatuses, different coding parameters may also be allocated to different second apparatuses in a same manner.

When the ZC sequence is used as the phase coding sequence, a spectrum obtained by multiplying any two phase codes has a constant modulus characteristic. In this case, a corresponding time domain signal is an ideal impulse function, which is conducive to obtaining an accurate detection result. However, if there is no constant modulus characteristic, a corresponding time-domain signal has a side lobe, which is not conducive to obtaining an accurate detection result.

In another possible design, the phase coding sequence is an m-sequence limited to a binary field. The coding parameter for the phase coding is a cyclic shift of the m-sequence. Each FMCW signal corresponds to one cyclic shift. Different FMCW signals correspond to different cyclic shifts.

If phase coding is limited to the binary field, different cyclic shifts of the m-sequence also have phase coding similar to the constant modulus characteristic. Therefore, the cyclic shift of the m-sequence can also be used as a coding parameter for phase coding.

The binary field is a field with only two elements (for example, 1 and −1). If phase coding is limited to the binary field, the m-sequence may be a sequence including 1 and −1. The cyclic shift may be an offset of a first element of a sequence obtained after cyclic shifting is performed on the m-sequence with a sequence as a period relative to a first element of a sequence before cyclic shifting.

FIG. 13 is a diagram of two FMCW signals generated through phase coding based on different coding parameters according to an embodiment of this application. The coding parameter shown in the figure is a cyclic shift of an m-sequence. A sequence 1 is [−1, 1, −1, −1, 1, 1, 1, −1, 1, −1], where [−1, 1, −1] is a cyclic prefix. A sequence 2 is [−1, 1, 1, 1, −1, 1, −1, −1, 1, 1], where [−1, 1, 1] is a cyclic prefix. Duration of a single element in the sequence is referred to as a chip period. In other words, a minimum time length occupied by each element (for example, 1 or −1) in the sequence is a chip period. It can be learned that the cyclic prefixes of the two m-sequences are three chip periods, and correspond to maximum round-trip latencies τₘₐₓ of the FMCW signals. A second apparatus starts processing after receiving an echo signal, and a maximum period of time from a time when the second apparatus transmits an FMCW signal to a time when the second apparatus receives an echo signal of the FMCW signal is τₘₐₓ. Therefore, the m-sequence may be obtained by performing cyclic shifting starting from the fourth chip period based on a period of [−1, 1, −1, −1, 1, 1, 1]. In other words, a period of the cyclic shifting is seven chip periods. A cyclic shift of the sequence 1 is 0. A cyclic shift of the sequence 2 is 4. For a receive end, duration of the FMCW signal is seven chip periods except the cyclic prefix of three chip periods. Therefore, T/T_{c}=7. The sequence 1 and the sequence 2 are used as phase coding sequences. Phase coding is performed on a same FMCW signal, so that a signal 1 and a signal 2 may be obtained, as shown in the figure.

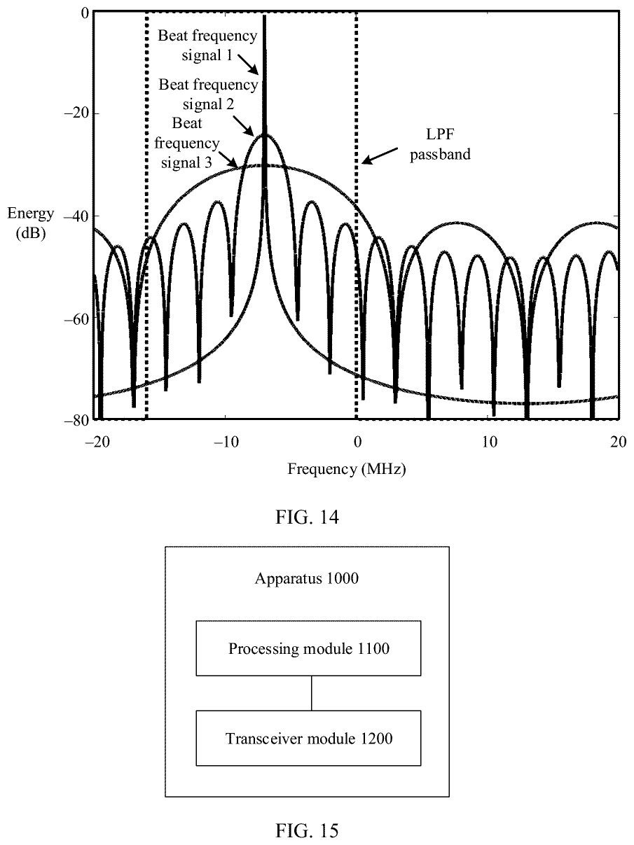

FIG. 14 is a diagram of interference levels of a plurality of FMCW signals generated through phase coding based on different phase codes (for example, cyclic shifts) and/or m-sequences with different T/T_{c} values according to an embodiment of this application. The plurality of FMCW signals include FMCW signals generated by using sequences whose T/Tc values are respectively 256 and 1024 as phase coding sequences, which may specifically include signals a and b with a T/T_{c} value of 256 and different phase codes, and signals c and d with a T/T_{c} value of 1024 and different phase codes.

Energy of beat frequency signals is shown in FIG. 14. As shown in the figure, after an echo signal a′ of the signal a and an echo signal b′ of the signal b are received by a second apparatus from which the signal a eminates, a frequency mixer may output beat frequency signals based on the locally generated signal a and the received echo signals a′ and b′. The frequency mixer may output a beat frequency signal 1 based on the locally generated signal a and the received echo signal a′. The frequency mixer may output a beat frequency signal 2 based on the locally generated signal a and the received echo signal b′. Similarly, after an echo signal c′ of the signal c and an echo signal d′ of the signal d are received by a second apparatus from which the signal c eminates, a frequency mixer may output beat frequency signals based on the locally generated signal c and the received echo signals c′ and d′. The frequency mixer may output a beat frequency signal 1 based on the locally generated signal c and the received echo signal c′. The frequency mixer may output a beat frequency signal 3 based on the locally generated signal c and the received echo signal d′.

An energy peak (namely, a main lobe) of the beat frequency signal 1 is obvious and falls within a passband of a low-pass filter. An energy peak of the beat frequency signal 2 is lower than the energy peak of the signal 1 and falls within the passband of the low-pass filter. An energy peak of the beat frequency signal 3 is lower than the energy peaks of the signal 1 and the signal 2, and almost occupies the entire passband of the low-pass filter. The beat frequency signal 2 and the beat frequency signal 3 interfere with the beat frequency signal 1 to some extent, but the interference is small. Therefore, phase coding multiplexing may also be used as a multiplexing mode. A maximum multiplexing quantity that can be supported by phase coding multiplexing is └Bτₘₐₓ┘−1.

Additionally, if T/T_{c} is further increased, a width of the main lobe is further increased, and the energy peak may fall outside the passband of the filter, which is not conducive to distinguishing from a side lobe and obtaining an accurate detection result. Therefore, T/T_{c} needs to be controlled within a specific range.

The foregoing phase coding sequences are merely two possible designs, and this application includes but is not limited thereto. Based on a same concept, a person skilled in the art may use another sequence as the phase coding sequence, provided that a spectrum obtained by multiplying any two phase codes has, or approximately has, a constant modulus characteristic.

Further, if phase coding multiplexing is combined with another multiplexing mode, a maximum multiplexing quantity may be multiplied. For example, if phase coding multiplexing is combined with shift multiplexing, the maximum multiplexing quantity that can be supported is └T/τₘₐₓ┘(└Bτₘₐₓ┘−1). If phase coding multiplexing is combined with conjugate symmetric multiplexing, the maximum multiplexing quantity that can be supported is 2(└Bτₘₐₓ┘−1). If phase coding multiplexing is combined with slope multiplexing, the maximum multiplexing quantity that can be supported is 2/(1−4q²Δk)┘(└Bτₘₐₓ┘−1). If phase coding multiplexing is combined with shift multiplexing, conjugate symmetric multiplexing, and slope multiplexing, the maximum multiplexing that can be is quantity supported 2└T/τₘₐₓ┘└2/(1−4q²Δk)┘(└Bτₘₐₓ┘−1). By analogy, if phase coding multiplexing is combined with any one or more multiplexing modes, the maximum multiplexing quantity that can be supported is a product of the maximum multiplexing quantities that can be supported by the plurality of multiplexing modes used in combination.

An interference level of slope multiplexing is lower than an interference level of phase coding multiplexing and higher than interference levels of conjugate symmetric multiplexing and shift multiplexing, and the interference level of conjugate symmetric multiplexing is higher than the interference level of shift multiplexing. Therefore, if a multiplexing quantity is small, shift multiplexing may be preferentially used. If a multiplexing quantity is large, one or more of conjugate symmetric multiplexing, slope multiplexing, or phase coding multiplexing may be used in combination. For example, as the multiplexing quantity increases, conjugate symmetric multiplexing, slope multiplexing, and phase coding multiplexing are sequentially used in combination.

In a possible design, if a multiplexing quantity N is less than or equal to └T/τₘₐₓ┘, the target multiplexing mode includes shift multiplexing. If the multiplexing quantity N is greater than └τₘₐₓ┘ and less than or equal to 2└τₘₐₓ┘, the target multiplexing mode includes shift multiplexing and conjugate symmetric multiplexing. If the multiplexing quantity N is greater than 2└τₘₐₓ┘ and less than or equal to 2└τₘₐₓ┘└2/(1−4q²Δk)┘, the target multiplexing mode includes shift multiplexing, conjugate symmetric multiplexing, and slope multiplexing. If the multiplexing quantity N is greater than 2└T/τₘₐₓ┘└2/(1−4q²Δk)┘, the target multiplexing mode includes shift multiplexing, conjugate symmetric multiplexing, slope multiplexing, and phase coding multiplexing.

The foregoing formulas 7 and 8 are merely examples. A person skilled in the art may make simple transformations on them, for example, introduce a time shift.

The following provides a possible variation as an example. However, it should be understood that this variation is merely an example, and there may be other variations. This is not limited in this application.

$$s ( t ) = rect ( \frac{t - τ - T / 2}{T} ) c ( t - τ ) {e}^{j 2 π [ ( {f}_{c} + kT / 2 ) ( t - τ ) - {k ( t - τ )}^{2} / 2 ]} , \qquad Formula 7 - 1$$

$$c ( t ) = {\sum }_{l = 1}^{T / {T}_{c}} {c}_{r , l} rect ( \frac{t - l {T}_{c} / 2}{{T}_{c}} ) , r = 1 , 2 , … , ⌊ B {τ}_{max} ⌋ - 1$$

$$s ( t ) = rect ( \frac{t - τ - T / 2}{T} ) c ( t - τ ) {e}^{j 2 π [ ( {f}_{c} - kT / 2 ) ( t - τ ) + {k ( t - τ )}^{2} / 2 ]} , \qquad Formula 8 - 1$$

$$c ( t ) = {\sum }_{l = 1}^{T / {T}_{c}} {c}_{r , l} rect ( \frac{t - l {T}_{c} / 2}{{T}_{c}} ) , r = 1 , 2 , … , ⌊ B {τ}_{max} ⌋ - 1$$

It should be understood that the foregoing possible variation is merely an example. A person skilled in the art may further convert the time shift into a frequency shift, or combine phase coding multiplexing with another multiplexing mode to obtain other possible variations, which are not enumerated herein.

Based on the foregoing description of the four multiplexing modes, it may be summarized as shown in Table 2.

TABLE 2

| Multi- | | | | Maximum |
|---|---|---|---|---|
| plexing | | | Interference | multiplexing |
| mode | Sequence design | Parameter | level | quantity |
| Shift | τₙ = (n − 1) τₘₐₓ | n or τₙ | 0 | └T/τₘₐₓ┘ |
| multi- | | | | |
| plexing | | | | |
| Conjugate symmetric multi- | e^{j2π[(f}^{_{c}}^{∓kT/2)t±kt}^{²}^{/2]} or ∓kt(t ± T)/2 | Plus-minus sign | $\frac{k}{2 {B}^{2}}$ | 2 |
| plexing | | | | |
| Slope multi- plexing | ${k}_{m} = \frac{1 - \sqrt{1 - 4 {qk}_{m - 1}}}{2 q}$ | k | $\frac{1}{{B}^{2} q}$ | └2/(1 − 4q²Δk)┘ |
| Phase coding multi- | $c ( t ) = {\sum }_{l = 1}^{T / {T}_{c}} {c}_{l} rect ( \frac{t - l {T}_{c} / 2}{{T}_{c}} )$ | r | $\frac{1}{B {τ}_{max}}$ | └Bτₘₐₓ┘ − 1 |
| plexing | | | | |

In Table 2, the interference level increases sequentially from top to bottom. Therefore, the four multiplexing modes may be classified into four multiplexing levels. The first multiplexing level includes the shift multiplexing mode, and the maximum multiplexing quantity that can be supported is └T/τₘₐₓ┘. The second multiplexing level includes the shift multiplexing mode and the conjugate symmetric multiplexing mode, and the maximum multiplexing quantity that can be supported is 2└T/τₘₐₓ┘. The third multiplexing level includes the shift multiplexing mode, the conjugate symmetric multiplexing mode, and the slope multiplexing mode, and the maximum multiplexing quantity that can be supported is 2└τₘₐₓ┘└2/(1−4q²Δk)┘. The fourth multiplexing level includes the shift multiplexing mode, the conjugate symmetric multiplexing mode, the slope multiplexing mode, and the phase coding multiplexing mode, and the maximum multiplexing quantity that can be supported is 2└τₘₐₓ┘└2/(1−4q²Δk)┘(└Bτₘₐₓ┘−1).

For different multiplexing modes, parameters that may need to be indicated by the first apparatus are shown in Table 3.

TABLE 3

| Multiplexing mode | Multiplexing quantity N | Parameter |
|---|---|---|
| Shift multiplexing | Greater than or equal to 1 and less | Value of n or τₙ |
| | than or equal to └T / τₘₐₓ┘ | |
| Shift multiplexing and | Greater than └T / τₘₐₓ┘ | Value of n or τₙ, |
| conjugate symmetric | and less than or equal | and plus-minus sign |
| multiplexing | to 2└T / τₘₐₓ┘ | of k |
| Shift multiplexing, | Greater than 2└T / τₘₐₓ┘ and less than | Value of n or τₙ, |
| conjugate symmetric | or equal to 2└T / τₘₐₓ┘└2/(1 − 4q²Δk)┘ | and value and plus- |
| multiplexing, and | | minus sign of k |
| slope multiplexing | | |
| Shift multiplexing, | Greater than 2└T / τₘₐₓ┘└2/(1 − 4q²Δk)┘ | Value of n or τₙ, |
| conjugate symmetric | and less than or equal to | value and plus- |
| multiplexing, slope | 2└T / τₘₐₓ┘└2/(1 − 4q²Δk)┘(└Bτₘₐₓ┘ − 1) | minus sign of k, and |
| multiplexing, and | | value of r |
| phase coding | | |
| multiplexing | | |

Table 3 is merely an example. The foregoing correspondences may alternatively be embodied in another form. For example, refer to Table 4 below. In addition, ranges of multiplexing quantities N or parameters corresponding to different multiplexing modes may also be adjusted. For example, a multiplexing quantity N corresponding to shift multiplexing and conjugate symmetric multiplexing may be greater than └T/τₘₐₓ┘. A multiplexing quantity N corresponding to shift multiplexing, conjugate symmetric multiplexing, and slope multiplexing may be greater than 2└T/τₘₐₓ┘. A multiplexing quantity N corresponding to shift multiplexing, conjugate symmetric multiplexing, slope multiplexing, and phase coding multiplexing may be greater than 2└T/τₘₐₓ┘└2/(1−4q²Δk). For another example, the first apparatus may not distinguish between multiplexing modes, and may determine the value of n or τₙ, the value and plus-minus sign of k, and the value of r for each second apparatus.

Based on the correspondences shown in Table 3, in a possible implementation of step 510, the first apparatus may prestore a correspondence between a range of a multiplexing quantity N corresponding to each multiplexing mode and a parameter that needs to be indicated; and after determining the multiplexing quantity, determine the target multiplexing mode, determine, based on a parameter that needs to be indicated and that corresponds to the target multiplexing mode, values that need to be indicated to different second apparatuses, and generate parameter information for the different second apparatuses.

In another implementation, various multiplexing modes in Table 3 and combinations thereof may also be defined as multiplexing levels. Each multiplexing level may include one or more multiplexing modes. It may be understood that the target multiplexing mode belongs to a target multiplexing level. In other words, the target multiplexing level includes the target multiplexing mode. Table 3 may further be transformed into Table 4.

TABLE 4

| Multiplexing | | |
|---|---|---|
| level | Multiplexing quantity N | Parameter |
| First | Greater than or equal to 1 and less than or | Value of n or τₙ |
| multiplexing | equal to └T / τₘₐₓ┘ | |
| level | | |
| Second | Greater than └T / τₘₐₓ┘ and less than or equal | Value of n or τₙ, and |
| multiplexing | to 2└T / τₘₐₓ┘ | plus-minus sign of k |
| level | | |
| Third | Greater than 2└T / τₘₐₓ┘ and less than or equal | Value of n or τₙ, and |
| multiplexing | to 2└T / τₘₐₓ┘└2/(1 − 4q²Δk)┘ | value and plus-minus |
| level | | sign of k |
| Fourth | Greater than 2└T / τₘₐₓ┘└2/(1 − 4q²Δk)┘ and | Value of n or τₙ, value |
| multiplexing | less than or equal to | and plus-minus sign |
| level | 2└T / τₘₐₓ┘└2/(1 − 4q²Δk)┘(└Bτₘₐₓ┘ − 1) | of k, and value of r |

Similar to Table 3, Table 4 is merely an example. The foregoing correspondences may alternatively be embodied in another form. For example, refer to Table 4. In addition, ranges of multiplexing quantities N or parameters corresponding to different multiplexing modes may also be adjusted.

Based on the correspondences shown in Table 4, in another possible implementation of step 510, the first apparatus may prestore a correspondence between a range of a multiplexing quantity N corresponding to each multiplexing level and a parameter that needs to be indicated; and after determining the multiplexing quantity, determine the target multiplexing level, determine, based on a parameter that needs to be indicated and that corresponds to the target multiplexing level, values that need to be indicated to different second apparatuses, and generate parameter information for the different second apparatuses.

In step 520, the first apparatus may send the parameter information to each second apparatus through an air interface, for example, a Uu interface.

In a possible design, the second apparatus is mounted in a terminal, for example, a vehicle or an unmanned aerial vehicle. Because the terminal has a wireless communication module, the terminal may receive the parameter information from the first apparatus, and may further sends the received parameter information to the second apparatus.

The second apparatus may be used as an independent device. The second apparatus may also be configured with a wireless communication module, configured to receive the parameter information from the first apparatus.

In addition, in this specification, the first apparatus is used as an example of the first apparatus, and should not constitute any limitation on this application. As described above, the first apparatus may alternatively be a server, for example, a cloud server. The server may send the parameter information to each second apparatus through the air interface or optical fiber communication. For methods of receiving the parameter information by each second apparatus, refer to the foregoing description. Details are not described again.

In step 530, the second apparatus may generate the FMCW signal based on the parameter information. The second apparatus may preconfigure a formula used to generate the FMCW signal; and after receiving the parameter information, generate the FMCW signal based on the formula and the indicated value of each parameter.

For example, the formula s(t) used to generate the FMCW signal is as follows:

$$s ( t ) = ( \frac{t - τ - T / 2}{T} ) c ( t - τ ) {e}^{j 2 π [ ( {f}_{c} ∓ kT / 2 ) ( t - τ ) + {k ( t - τ )}^{2} / 2 ]}$$

For definitions of the parameters, refer to the foregoing description. Details are not described again.

Although the formula includes the time shift, slope, and phase coding, it does not indicate that it is necessary to use the following four multiplexing modes in combination to multiplex a resource for the FMCW signal: shift multiplexing, conjugate symmetric multiplexing, slope multiplexing, and phase coding multiplexing.

For example, when shift multiplexing is used, although values of other parameters may be indicated by the first apparatus, the values of the parameters indicated to the second apparatuses may be the same. For example, absolute values of slopes are the same, plus-minus signs are the same, and coding parameters of phase coding are the same. The rest may be deduced by analogy, and details are not described again.

In step 540, the second apparatus may transmit the generated FMCW signal through a transmitter antenna, to perform detection based on a received echo signal.

A method for performing detection by the second apparatus based on the local FMCW signal and the received echo signal is described above with reference to FIG. 3. For a specific process, refer to the conventional technology. A specific implementation of the method is not limited in this application.

Based on the foregoing solution, the first apparatus may determine and send the parameter information for different second apparatuses. Each second apparatus may receive, from the first apparatus, specific values of one or more parameters used to generate the FMCW signal, and generate the FMCW signal based on the parameter information. The one or more parameters included in the parameter information correspond to various multiplexing modes. The multiplexing modes are intended to suppress interference between signals on the basis of sharing a same resource. Therefore, when resources used by a plurality of second apparatuses overlap, interference between FMCW signals generated based on the parameter information can also be suppressed. In addition, when determining a parameter for each second apparatus, the first apparatus selects a multiplexing mode based on a multiplexing quantity. When selecting the multiplexing mode, the first apparatus may select a plurality of multiplexing modes in order of interference level for use in combination, so that interference between signals can be suppressed to a greater extent. In addition, the first apparatus may allocate different parameter values to different second apparatuses. This can avoid a collision that may occur when a plurality of second apparatuses select a same parameter value, and facilitates interference suppression. Therefore, overall, the method provided in this application can effectively suppress interference between signals of a plurality of second apparatuses, to help improve the accuracy of a detection result obtained based on an FMCW signal.

The foregoing describes the method provided in embodiments of this application with reference to a plurality of accompanying drawings. The following describes apparatuses provided in embodiments of this application with reference to the accompanying drawings.

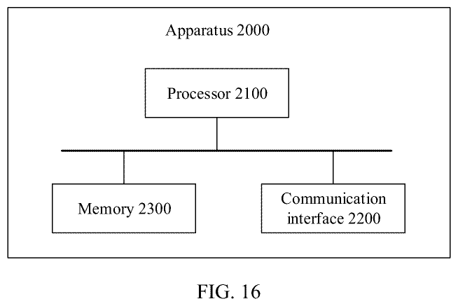

FIG. 15 and FIG. 16 are block diagrams of communication apparatuses according to embodiments of this application. These apparatuses may be configured to implement the functions of the first apparatus or the second apparatus in the foregoing method embodiments, and therefore may also implement beneficial effects of the foregoing method embodiments.

As shown in FIG. 15, a communication apparatus 1000 includes a processing module 1100 and a transceiver module 1200.

In a possible design, the communication apparatus 1000 is configured to implement the functions of the first apparatus in the method embodiment shown in FIG. 5.

For example, the processing module 1100 may be configured to generate parameter information. The parameter information indicates a value of at least one of the following parameters: a time shift of a time for transmitting an FMCW signal relative to a reference time, a slope of the FMCW signal, a plus-minus sign of the slope, and a coding parameter used to generate the FMCW signal through phase coding. The parameter information is used to generate the FMCW signal. The transceiver module 1200 may be configured to send the parameter information.

For more detailed descriptions of the processing module 1100 and the transceiver module 1200, directly refer to related descriptions in the method embodiment shown in FIG. 5. Details are not described herein again.

In another possible design, the communication apparatus 1000 is configured to implement the functions of the second apparatus in the method embodiment shown in FIG. 5.

For example, the transceiver module 1200 may be configured to receive parameter information. The processing module 1100 may be configured to generate an FMCW signal based on the parameter information. The transceiver module 1200 may be further configured to transmit the FMCW signal.

It should be noted that if the apparatus 1000 is the second apparatus, the second apparatus may be a second apparatus mounted in the terminal device, or an independently used second apparatus. If the second apparatus is the second apparatus mounted in the terminal device, the second apparatus may receive the parameter information from the terminal device through a communication interface, and may send the FMCW signal through a transmitter antenna of the second apparatus. If the second apparatus is the independently used second apparatus, the second apparatus may be configured with a communication interface configured to receive signaling, such as a receiver antenna or an optical fiber interface. The second apparatus may further be configured with a transmitter antenna configured to transmit the FMCW signal.

If the second apparatus is a transceiver, when being configured to transmit the FMCW signal, the transceiver module 1200 may be specifically configured to radiate the FMCW signal to space. If the second apparatus is a chip or a chip system disposed in a transceiver, when being configured to transmit the FMCW signal, the transceiver module 1200 may be specifically configured to output the FMCW signal.

For more detailed descriptions of the processing module 1100 and the transceiver module 1200, directly refer to related descriptions in the method embodiment shown in FIG. 5. Details are not described herein again.

The communication apparatus 1000 may include a sending unit, but does not include a receiving unit. Alternatively, the communication apparatus 1000 may include a receiving unit, but does not include a sending unit. This may be specifically determined based on whether the foregoing solution performed by the communication apparatus 1000 includes a sending action and a receiving action.

As shown in FIG. 16, a communication apparatus 2000 includes a processor 2100. The processor 2100 may be configured to execute a computer program or instructions in a memory, to implement the steps performed by the first apparatus or the steps performed by the second apparatus in the method embodiment shown in FIG. 5.

Optionally, the communication apparatus 2000 further includes a communication interface 2200. The processor 2100 and the communication interface 2200 are coupled to each other. It may be understood that the communication interface 2200 may be a transceiver or an input/output interface.

Optionally, the communication apparatus 2000 further includes a memory 2300 configured to store the instructions executed by the processor 2100, input data required by the processor 2100 to run the instructions, or data generated after the processor 2100 runs the instructions.

When the communication apparatus 2000 is configured to implement the method shown in FIG. 5, the processor 2100 is configured to perform the function of the foregoing processing module, and the communication interface 2200 is configured to perform the function of the foregoing receiving module and/or sending module. Whether the communication interface 3200 is used for sending or receiving may be specifically determined based on whether the communication apparatus 2000 is configured to perform a sending action or a receiving action in the solution performed by the communication apparatus 2000.

When the communication apparatus 2000 is a communication device (such as a base station, a server, or a terminal) corresponding to the first apparatus, the communication interface 2200 may be a transceiver, and may specifically include a transmitter and a receiver. The transmitter is configured to send a signal, and the receiver is configured to receive a signal.

When the communication apparatus 2000 is a chip disposed in a communication device, the chip may be configured to implement a function of the communication device in the foregoing method embodiment. The communication interface 2200 may be an input/output circuit. An input circuit may be used for receiving, and an output circuit may be used for sending. The input/output circuit may be configured to receive a signal from and send a signal to another module (such as a radio frequency module or an antenna).

When the communication apparatus 2000 is a communication device (such as a transceiver or a terminal configured with a transceiver) corresponding to the second apparatus, the communication interface 2200 may be a transceiver, and may specifically include a transmitter and a receiver. The transmitter is configured to send a signal, and the receiver is configured to receive a signal.

When the apparatus 2000 is a chip disposed in a communication device, the chip may be configured to implement a function of the second apparatus in the foregoing method embodiment. The communication interface 2200 may be an input/output circuit. An input circuit may be used for receiving, and an output circuit may be used for sending. The input/output circuit may be configured to receive a signal from and send a signal to another module (such as a radio frequency module or an antenna).

A specific connection medium between the processor 2100, the communication interface 2200, and the memory 2300 is not limited in embodiments of this application. In embodiments of this application, in FIG. 16, the processor 2100, the communication interface 2200, and the memory 2300 are connected through a bus. The bus is represented by a thick line in FIG. 16, and connections between other components is merely described as an example, and is not limited thereto. Buses may be classified into an address bus, a data bus, a control bus, and the like. For ease of representation, the bus in FIG. 16 is represented by only one thick line, but which does not indicate that there is only one bus or one type of bus.

It may be understood that the processor in embodiments of this application may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor, any regular processor, or the like.

The memory in embodiments of this application may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. Through example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchronous link dynamic random access memory (SLDRAM), and a direct rambus dynamic random access memory (DR RAM). It should be noted that the memory of the systems and methods described in this specification includes but is not limited to these and any memory of another proper type.

This application further provides a communication system. The communication system includes the foregoing first apparatus and second apparatus. Optionally, the first apparatus is a base station. Optionally, the second apparatus is a transceiver, or a terminal device in which a transceiver is mounted.

This application further provides a computer program product. The computer program product includes a computer program (which may also be referred to as code or instructions). When the computer program is run, a computer is enabled to perform the method performed by the first apparatus or the method performed by the second apparatus in the embodiment shown in FIG. 5.

This application further provides a computer-readable storage medium. The computer-readable storage medium stores a computer program (which may also be referred to as code or instructions). When the computer program is run, a computer is enabled to perform the method performed by the first apparatus or the method performed by the second apparatus in the embodiment shown in FIG. 5.

Terms such as “unit” and “module” used in this specification may indicate computer-related entities, hardware, firmware, combinations of hardware and software, software, or software being executed.

A person of ordinary skill in the art may be aware that, in combination with illustrative logical blocks described in embodiments disclosed in this specification and steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application. In several embodiments provided in this application, it should be understood that the disclosed apparatuses, devices, and methods may be implemented in other manners. For example, the described apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, or each of the units may exist alone physically, or two or more units are integrated into one unit.

In the foregoing embodiments, all or some of the functions of the function units may be implemented by using software, hardware, firmware, or any combination thereof. When software is used to implement the embodiments, all or a part of the embodiments may be implemented in a form of a computer program product. The computer program product includes one or more computer instructions (programs). When the computer program instructions are loaded and executed on a computer, the procedures or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device such as a server or a data center that integrates one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

When functions are implemented in the form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, or a network device) to perform all or some of the steps of the method described in embodiments of this application. The foregoing storage medium includes any medium that can store program code, such as a USB flash drive, a removable hard disk, a ROM, a RAM, a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An information transmission method, comprising:
generating, by a first apparatus, parameter information that indicates at least one of a time shift of a time for transmitting a frequency modulated continuous wave (FMCW) signal, s(t), relative to a reference time, a slope of the FMCW signal, a plus-minus sign of the slope, and a coding parameter used to generate the FMCW signal through phase coding, wherein the parameter information is used to generate the FMCW signal; and
sending, by the first apparatus, the parameter information to a second apparatus.

2. The method according to claim 1, wherein the parameter information is determined based on a target multiplexing mode that comprises one or more of shift multiplexing, conjugate symmetric multiplexing, slope multiplexing, and phase coding multiplexing, wherein
the shift multiplexing requires that a same time-frequency resource is shared by FMCW signals generated based on different time shifts,
the conjugate symmetric multiplexing requires that the same time-frequency resource is shared by two conjugate symmetric FMCW signals,
the slope multiplexing requires that the same time-frequency resource is shared by FMCW signals generated based on different slopes, and
the phase coding multiplexing requires that the same time-frequency resource is shared by FMCW signals generated through phase coding based on different values of the coding parameter.

3. The method according to claim 2, wherein generating the parameter information comprises:
generating the parameter information for each of a plurality of transceivers sharing the same time-frequency resource, wherein the parameter information generated for each transceiver is determined based on the target multiplexing mode; and
sending the parameter information comprises:
sending to each transceiver of the plurality of transceivers the parameter information corresponding to that transceiver.

4. The method according to claim 3, wherein the target multiplexing mode comprises the shift multiplexing, and the parameter information sent to each transceiver of the plurality of transceivers includes different time shifts for any two of the transceivers of the plurality of transceivers.

5. The method according to claim 4, wherein a time shift τₙ indicated by the parameter information for the n^{th} transceiver in the plurality of transceivers meets the condition τₙ=(n−1)τₘₐₓ, where n is an integer from 1 to └T/τₘₐₓ┘, T is a duration of the FMCW signal, and τₘₐₓ is a maximum round-trip latency of the FMCW signal.

6. The method according to claim 3, wherein the target multiplexing mode comprises the shift multiplexing and the conjugate symmetric multiplexing, and the parameter information sent to each transceiver of the plurality of transceivers includes at least one of different time shifts and different plus-minus signs of the slopes as between parameter information sent to any two of the plurality of transceivers.

7. The method according to claim 6, wherein the plurality of transceivers comprise a first transceiver and a second transceiver, and in the parameter information sent to the first transceiver and the parameter information sent to the second transceiver, time shifts are the same but plus-minus signs of the slopes are different, so that an FMCW signal s₁(t) of the first transceiver and a signal s₂(t) of the second transceiver meet the conditions
$${s}_{1} ( t ) = rect ( \frac{t - T / 2}{T} ) {e}^{j 2 π [ ( {f}_{c} - kT / 2 ) t + {kt}^{2} / 2 ]}$$
$${s}_{2} ( t ) = rect ( \frac{t - T / 2}{T} ) {e}^{j 2 π [ ( {f}_{c} + kT / 2 ) t - {kt}^{2} / 2 ]}$$
wherein t is a time variable, T is the duration of the FMCW signal, f_{c} is a carrier frequency of the FMCW signal, and k is the slope of the FMCW signal.

8. The method according to claim 3, wherein the target multiplexing mode comprises the shift multiplexing, the conjugate symmetric multiplexing, and the slope multiplexing, and the parameter information sent to each transceiver of the plurality of transceivers includes at least one of different time shifts, different absolute values of the slopes, and different plus-minus signs of the slopes as between parameter information sent to any two of the plurality of transceivers.

9. The method according to claim 8, wherein slopes for the plurality of transceivers comprise k₁, k₂, . . . , and kₘ, wherein k₁<k₂< . . . <kₘ₋₁<kₘ,
$$\frac{{k}_{2} - {k}_{1}}{{k}_{2}^{2}} = \frac{{k}_{3} - {k}_{2}}{{k}_{3}^{2}} = … = \frac{{k}_{m} - {k}_{m - 1}}{{k}_{m}^{2}} = q ,$$
kₘ−k₁=Δk, q and Δk are predefined values, Δk=kₘ−k₁, and m=1, 2, . . . , └2/(1−4q²Δk)┘.

10. The method according to claim 3, wherein the target multiplexing mode comprises the shift multiplexing, the conjugate symmetric multiplexing, the slope multiplexing, and the phase coding multiplexing, and the parameter information sent to each transceiver of the plurality of transceivers includes different time shifts, different absolute values of the slopes, different plus-minus signs of the slopes, and different values of the coding parameter as between parameter information sent to any two of the plurality of transceivers.

11. The method according to claim 10, wherein
a phase coding sequence used for the phase coding is a Zadoff-Chu (ZC) sequence, and the coding parameter comprises a root sequence index in the ZC sequence; or
the phase coding is limited to a binary field, a sequence used for the phase coding is an m-sequence, and the coding parameter comprises a cyclic shift of the m-sequence.

12. The method according to claim 2, wherein the target multiplexing mode is determined from the plurality of multiplexing modes based on a multiplexing quantity of transceivers that transmit the FMCW signals by using the same time-frequency resource.

13. The method according to claim 12, wherein the target multiplexing mode meets at least one of the following conditions:
if the multiplexing quantity is less than or equal to a first threshold, the target multiplexing mode comprises the shift multiplexing;
if the multiplexing quantity is greater than the first threshold but less than or equal to a second threshold, the target multiplexing mode comprises the shift multiplexing and the conjugate symmetric multiplexing;
if the multiplexing quantity is greater than the second threshold but less than or equal to a third threshold, the target multiplexing mode comprises the shift multiplexing, the conjugate symmetric multiplexing, and the slope multiplexing; or
if the multiplexing quantity is greater than the third threshold, the target multiplexing mode comprises the shift multiplexing, the conjugate symmetric multiplexing, the slope multiplexing, and the phase coding multiplexing.

14. The method according to claim 13, wherein the first threshold is └T/τₘₐₓ┘, the second threshold is 2└T/τₘₐₓ┘, and the third threshold is 2└T/τₘₐₓ┘└2/(1−4q²Δk)┘; where
T is a duration of the FMCW signal, τₘₐₓ is a maximum round-trip latency of the FMCW signal, and q and Δk are predefined values.

15. The method according to claim 1, wherein the FMCW signal, s(t), meets the following condition:
$$s ( t ) = rect ( \frac{t - τ - T / 2}{T} ) c ( t - τ ) {e}^{j 2 π [ ( {f}_{c} ∓ kT / 2 ) ( t - τ ) \pm {k ( t - τ )}^{2} / 2 ]}$$
wherein rect(.) is a rectangular window function, t is a time variable, τ is the time shift relative to the reference time, T is a duration of the FMCW signal, f_{c} is the carrier frequency of the FMCW signal, k is the slope of the FMCW signal, c(t) is a function of the phase coding, where c(t) meets a condition
$$c ( t ) = {\sum }_{l = 1}^{T / {T}_{c}} {c}_{l} rect ( \frac{t - l {T}_{c} / 2}{{T}_{c}} ) ,$$
wherein T_{c} is a chip period of the phase coding and cₗ is a phase coding sequence.

16. A signal transmission method, comprising:
receiving parameter information that indicates at least one of a time shift of a time for transmitting a frequency modulated continuous wave (FMCW) signal, s(t), relative to a reference time, a slope of the FMCW signal, a plus-minus sign of the slope, and a coding parameter used to generate the FMCW signal through phase coding;
generating, by a first apparatus, the FMCW signal based on the parameter; and
transmitting, by the first apparatus, the FMCW signal.

17. The method according to claim 16, wherein the FMCW signal, s(t), meets the condition:
$$s ( t ) = ( \frac{t - τ - T / 2}{T} ) c ( t - τ ) {e}^{j 2 π [ ( {f}_{c} ∓ kT / 2 ) ( t - τ ) + {k ( t - τ )}^{2} / 2 ]}$$
where rect(.) is a rectangular window function, t is a predefined reference time, τ is the time shift relative to the reference time, T is a duration of the FMCW signal, f_{c} is a carrier frequency of the FMCW signal, k is the slope of the FMCW signal, c(t) is a function of the phase coding, and c(t) meets a condition
$$c ( t ) = {\sum }_{l = 1}^{T / {T}_{c}} {c}_{l} rect ( \frac{t - {lT}_{c} / 2}{{T}_{c}} ) ,$$
wherein T_{c} is a chip period of the phase coding and cₗ is a phase coding sequence.

18. A first communication apparatus, comprising:
a processing unit configured to generate parameter information indicates at least one of a time shift of a time for transmitting a frequency modulated continuous wave (FMCW) signal relative to a reference time, a slope of the FMCW signal, a plus-minus sign of the slope, and a coding parameter used to generate the FMCW signal through phase coding, wherein the parameter information is used to generate the FMCW signal; and
a communication unit configured to send the parameter information to a second apparatus.

19. The first communication apparatus according to claim 18, wherein the parameter information is determined based on a target multiplexing mode that comprises one or more of shift multiplexing, conjugate symmetric multiplexing, slope multiplexing, and phase coding multiplexing, wherein
the shift multiplexing requires that a same time-frequency resource is shared by FMCW signals generated based on different time shifts,
the conjugate symmetric multiplexing requires that the same time-frequency resource is shared by two conjugate symmetric FMCW signals,
the slope multiplexing requires that the same time-frequency resource is shared by FMCW signals generated based on different slopes, and
the phase coding multiplexing requires that the same time-frequency resource is shared by FMCW signals generated through phase coding based on different values of the coding parameter.

20. The first communication apparatus according to claim 19, wherein the processing unit is further configured to generate the parameter information by:
generating the parameter information for each of a plurality of transceivers sharing the same time-frequency resource, wherein the parameter information generated for each transceiver is determined based on the target multiplexing mode; and
the communication unit is further configured to send the parameter information by:
sending to each transceiver of the plurality of transceivers the parameter information corresponding to that transceiver.
